(19) United States
(12) Patent Application Publication
(10) Pub. No.: US 2014/0122396 A1
(43) Pub. Date: May 1, 2014

(54) RULES ENGINE AS A PLATFORM FOR MOBILE APPLICATIONS

(71) Applicant: QUALCOMM INCORPORATED, San Diego, CA (US)

(72) Inventors: Ashwin Swaminathan, San Diego, CA (US); Lukas Daniel Kuhn, San Diego, CA (US); Li Ding, San Diego, CA (US); Evan Patton, San Diego, CA (US)

(73) Assignee: QUALCOMM Incorporated, San Diego, CA (US)

(21) Appl. No.: 13/835,053

(22) Filed: Mar. 15, 2013

Related U.S. Application Data
(60) Provisional application No. 61/719,876, filed on Oct. 29, 2012.

(51) Int. Cl. G06N 99/00

(52) U.S. Cl. CPC G06N 99/005
USPC 706/14

(57) ABSTRACT

Disclosed are systems and methods to optimize a rules engine as a platform within a computing system. The computing system may identify a context of interest, such as environment or circumstance of the computing system or a user of the computing system. Based on the identified context of interest, the rules engine platform may selectively identify rules or sets of rules that are relevant to the context of interest. Accordingly, rules or sets of rules that are irrelevant to the context of interest may be omitted from evaluation. Therefore, resources of the computing system may not consumed in some embodiments by resolving conflicts between rules and evaluating rules that result in actions that are not suitable for the context of interest.

### RELATED APPLICATIONS

This application claims the benefit of U.S. Provisional Application No. 61/719,876, filed Oct. 29, 2012 and titled Rules Engine as a Platform for Mobile Applications, which is incorporated by reference herein in its entirety.

### BACKGROUND

1. Technical Field

The present invention relates generally to portable electronic devices, for example as implemented in a computing system.

2. Related Background

The use of portable electronic devices by the general population is ubiquitous across the globe. Such portable electronic devices can provide a user with one or more services such as wireless phone access, Internet access, email and messaging services, time and activity organization, location and mapping services, media presentation, and additional services. Examples of such portable electronic devices include: mobile devices, smart phones, cellular phones, personal digital assistants (PDAs), tablet computers, personal media players as well as any other type of portable electronic device offering similar functionality.

In the course of providing a range of services to a user, a portable electronic device may be operable to collect, observe and manage numerous attributes. Some attributes may be associated with the user of the device, such as a to-do list populated by items received through user input. Other attributes may be static and/or dynamic characteristics of the device, such as a device's random-access memory (RAM) capacity or the level of charge remaining on the device's battery. An application on the portable electronic device can cause the device to perform particular operations in response to such collected or observed attributes. For example, the application may cause the device to disable Wi-Fi connectivity when the observed battery charge is diminished. However, such applications are static at the point of implementation on the device, notwithstanding minor predefined options in the application (e.g., the user may configure the application to allow Wi-Fi connectivity even where the device's battery is considered “diminished”). A plurality of applications on a device each individually requesting attributes, such as battery charge or geographic location, is expensive for both a processor and a power source of the device.

### SUMMARY

Embodiments of the invention relate to a portable electronic device operable to provide a rules engine platform. In one embodiment, a rules engine platform in a portable electronic device may receive a plurality of rules for one or more modules (e.g., components) of the portable electronic device. Additionally, the rules engine can receive one or more samples from one or more of the modules within the portable electronic device. A sample may be raw input data from a sensor, processed data from a sensor, data from applications running on the portable electronic device such as a calendar, a user profile, social networking information, or any other data that may be provided by a module. In some embodiments, the sample comprises a sample derived by a context awareness engine, for example a motion state or classifier or a social environment or sample. Samples or inferences from samples may be asserted as facts, which the rules engine may match to one or more relevant rules. The rules engine may evaluate the relevant rule based an asserted fact to determine one or more actions (including evaluating another rule). In some embodiments, this evaluation of the rule comprises making one or more inferences based on one more received samples. Where a rule evaluates to true, the rules engine determines an action, which may include evaluating additional rules. This determined action can then be provided to other modules within the portable electronic device.

Embodiments of the invention include other components to optimize a rules engine as a platform within a portable electronic device. In many embodiments, a rules engine interface is provided in connection with the rules engine to optimize the rules engine as a platform. The rules engine interface may be configured to receive or monitor one or more samples from one or more modules and suitably adapt those one or more samples for the rules engine. As supplementary components of the platform, a rules repository and/or a knowledge repository may be provided in some embodiments. The rules repository may be configured to store a plurality of rules that are accessible by the rules engine. The knowledge repository may be operable to store a plurality of facts, such as samples or inferences. One or both of the repositories can maintain asset management, inference data and metadata associated with rules, samples or modules interacting with the rules engine.

In some embodiments, an apparatus comprises means for determining a first context of the system based on at least one of a received sample and an expected sample from a first sampling module; means for identifying at least one rule of a first plurality of rules, wherein the identified at least one rule is relevant to the first context; means for evaluating the identified relevant rule for the first context; and means for ignoring at least one rule remaining in the first plurality of rules that is irrelevant to the first context, such that the at least one rule is not evaluated for the first context. In some embodiments, the means for identifying the at least one relevant rule comprises means for identifying, from the first plurality of rules, a relevant rule set having a second plurality of rules that are relevant to the first context, including the at least one rule. In some embodiments, the apparatus further comprises means for evaluating each rule of the relevant rule set. In some embodiments, the apparatus further comprises means for identifying, from the first plurality of rules, a second rule set having a third plurality of rules that are relevant to the first context and are to be evaluated. In some embodiments, the first context is an office of a user and the relevant rule set is relevant for an office context. In some embodiments, the first context is one of a location and a geo-fence. In some embodiments, the first sampling module is one of a cellular module, a Bluetooth module, a Wi-Fi module, a user input module, a near-field communication module, a satellite positioning system module, or an application module stored in memory of the system. In some embodiments, the apparatus further comprises means for identifying at least one fact that is relevant to the first context. In some embodiments, the apparatus further comprises means for decomposing the relevant rule to identify the at least one fact required by the relevant rule. In some embodiments, the means for identifying the at least one fact that is relevant to the first context comprises means for identifying a relevant fact set having a plurality of facts that are relevant to the first context, including the at least one fact. In some embodiments, the apparatus further comprises means for asserting the at least one fact based on the first context. In some embodiments, the first context indicates that a user is driving and the at least one fact is asserted to indicate that the user is transitioning based on the first context. In some embodiments, the apparatus further comprises means for asserting a second fact that is not relevant to the first context to a default. In some embodiments, the means for asserting the second fact that is not relevant to the first context comprises means for identifying a second fact set having a plurality of facts that are not relevant to the first context, including the second fact; and means for asserting each fact of the plurality of facts in the second fact set to a default. In some embodiments, the apparatus further comprises means for determining a sampling requirement for at least one of a second received sample and a second expected sample that is provided by a second sampling module required to satisfy the relevant rule; means for computing an optimization scheme based on the sampling requirement of the relevant rule; and means for modifying a sampling rate of the second sampling module based on the optimization scheme. In some embodiments, the means for modifying the sampling rate comprises means for modifying a subscription to the second sampling module. In some embodiments, the apparatus further comprises means for determining a plurality of sampling requirements required to satisfy a rule set that is relevant to the first context, wherein the rule set comprises a plurality of rules including the relevant rule; means for computing an optimization scheme based on the plurality of sampling requirements of the relevant rule set; and means for modifying, based on the optimization scheme, a sampling rate of a second sampling module that is to provide at least one sample for a respective sampling requirement of the plurality of sampling requirements. In some embodiments, the means for computing the optimization scheme comprises: means for evaluating the plurality of sampling requirements; means for determining, from the evaluation of the plurality of sampling requirements, that a first sampling requirement of a first rule requires samples from the second sampling module at a first rate and a second sampling requirement of a second rule requires the samples from the second sampling module at a second rate that is different from the first rate; and means for computing an optimization parameter that specifies an optimal sampling rate of the second sampling module that is satisfactory for the first rule and the second rule. In some embodiments, the apparatus further comprises means for receiving a sample provided by the first sampling module, wherein the means for determining comprises: means for identifying a mapping between the sample that is to be provided and a stored context; and means for determining that the first context includes the stored context. In some embodiments, the sample is a Wi-Fi signature and the stored context is a room in a building. In some embodiments, the apparatus further comprises means for deriving a relationship between the first context and a second context. In some embodiments, the first context indicates that a user is at a home and the second context indicates that the user is at an office and the derived relationship includes a travel duration for the user to travel from the home to the office.

In some embodiments, a computing system comprises means for storing a plurality of rules in a rules repository; means for subscribing to a plurality of modules configured to provide a plurality of samples; means for identifying a context of interest based on the subscribing means; means for identifying a first set of rules that are relevant to the context of interest; and means for evaluating at least one rule included in the first set of rules. In some embodiments, the means for identifying the first set of rules includes means for ignoring a second set of rules that are not relevant to the context of interest. In some embodiments, the context of interest indicates that a user of the computing system is one of (1) in a meeting, (2) in a discussion, (3) on a call, (4) near a geo-fence, (5) near a person, (6) at home, or (7) driving. In some embodiments, the computing system further comprises means for identifying at least one fact that is relevant to the context of interest. In some embodiments, the computing system further comprises means for subscribing to a second sampling module and to modify the subscription to the second sampling module based on the context of interest.

In some embodiments, a method executed by a device comprises determining a first context of the device based on a least one sample provided by a first module; identifying a subset of rules in a first plurality of rules based on the first context, the subset of rules being applicable to the first context; and evaluating at least one rule in the subset of rules.

### BRIEF DESCRIPTION OF THE DRAWINGS

FIG. 1 is a block diagram of a portable electronic device according to one embodiment of the invention.

FIG. 2 is a sequence diagram illustrating a rules engine platform provided in a portable electronic device according to one embodiment of the invention.

FIG. 3A is a flow diagram illustrating a method performed by a rules engine in a portable electronic device according to one embodiment of the invention.

FIG. 3B is a flow diagram illustrating a method performed by a rules engine in a portable electronic device according to one embodiment of the invention.

FIG. 4 is a block diagram illustrating the components for creating a rule by a rules engine platform provided by a portable electronic device according to one embodiment of the invention.

FIG. 5 is a flow diagram illustrating a method for dynamically creating a rule by a rules engine platform provided by a portable electronic device according to one embodiment of the invention.

FIG. 6 is a flow diagram illustrating a method of asserting a fact to be used for evaluating a rule by a rules engine according to one embodiment of the invention.

FIG. 7A is a block diagram of a system that is optimized by implementing a rules engine platform according to one embodiment of the invention.

FIG. 7B is a block diagram of a rules repository within a rules engine platform according to one embodiment of the invention.

FIG. 7C is a block diagram of a knowledge repository within a rules engine platform according to one embodiment of the invention.

FIG. 8 is a flow diagram illustrating a method for optimizing a system that includes a rules engine according to one embodiment of the invention.

FIG. 9A is a flow diagram illustrating a method for optimizing a system that includes a rules engine according to one embodiment of the invention.

FIG. 9B is a flow diagram illustrating a method for optimizing a system that includes a rules engine according to one embodiment of the invention.

### DETAILED DESCRIPTION

Several embodiments of the invention with reference to the appended drawings are now explained. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The embodiments described herein provide a system and method for providing a rules engine as a platform in a computing system. The rules engine platform may be configured to identify a context of interest or may be able to access a context determined by another device or element. From the identified context of interest, the rules engine platform may selectively identify rules or sets of rules that are relevant to the context of interest. Accordingly, rules or sets of rules that are irrelevant to the context of interest may be omitted from evaluation. Similarly, facts or sets of facts that are relevant to the context of interest may be identified. The relevant facts may be used to evaluate the relevant rules, while facts that are not relevant to the context of interest may be ignored.

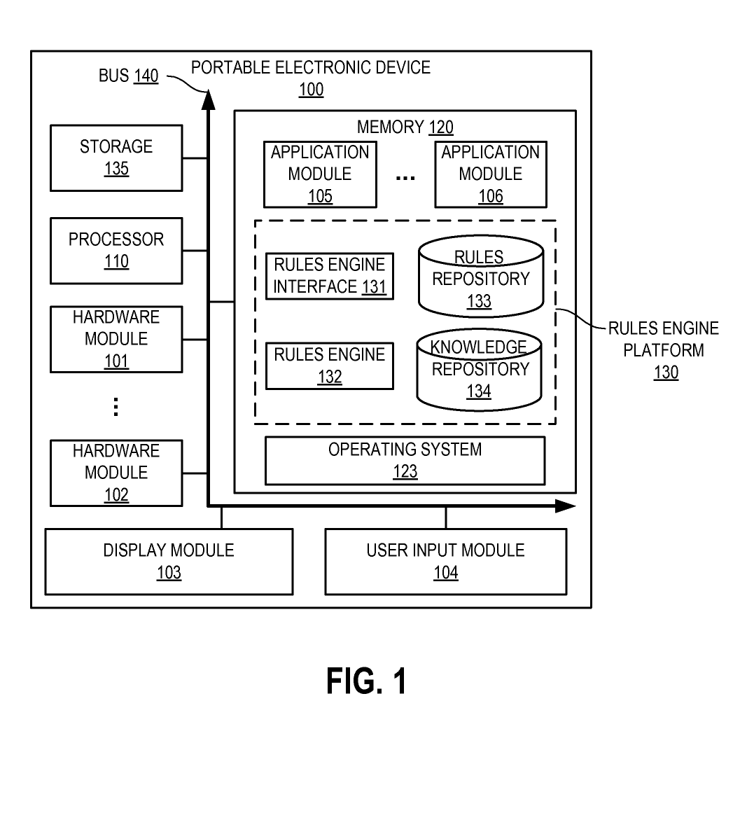

FIG. 1 is block diagram illustrating a system in which embodiments of the invention may be practiced. The system may be a portable electronic device 100, which may be any mobile device such as a smart phone, cellular phone, personal digital assistant, tablet computer, personal media player as well as any other type of portable electronic device offering similar or combined functionality. It should be appreciated that the device 100 may also include tactile buttons, a power device (e.g., a battery), as well as other components typically associated with a portable electronic device. Accordingly, FIG. 1 is not to be construed as limiting because some components are omitted.

In the embodiment shown at FIG. 1, the device 100 includes a processor 110 configured to execute instructions for performing operations at a number of components and can be, for example, a general-purpose processor or microprocessor suitable for implementation within a portable electronic device. The processor 110 is communicatively coupled with a plurality of components within the portable electronic device 100. In some embodiments, the processor 110 may reside inside the hardware module 101, 102. To realize this communicative coupling, the processor 110 may communicate with the other illustrated components across a bus 140. The bus 140 can be any subsystem adapted to transfer data within the device 100. The bus 140 can be a plurality of computer buses and include additional circuitry to transfer data. In some embodiments, the bus 140 is implemented in a System on Chip (SoC) and connects various elements or components on the chip and/or cores of one or more processors. The hardware modules 101, 102 could refer to the individual subsystems in the mobile device such as the audio subsystem, camera subsystem, sensor subsystem, by means of an example.

Both storage 135 and memory 120 may include instructions and data for the processor 110. Storage 135 can be implemented locally via the bus 140 (as shown) or remotely (e.g., cloud storage) via a network, such as a cellular data, Wi-Fi or WiMax network (not shown). In some embodiments, storage 135 includes non-volatile memory, such as read-only memory (ROM), flash memory, and the like. Furthermore, storage 135 can include removable storage devices, such as secure digital (SD) cards. Storage 135 can be, for example, conventional magnetic disks, optical disks such as CD-ROM or DVD based storage, magnetic tape storage, magneto-optical (MO) storage media, solid state disks, flash memory based devices, or any other type of storage devices suitable for storing data.

Memory 120 may offer both short-term and long-term storage and may in fact be divided into several units. Memory 120 may be volatile, such as static random access memory (SRAM) and/or dynamic random access memory (DRAM). Memory 120 may provide storage of computer readable instructions, data structures, application modules, and other data for the portable electronic device 100. Such data can be loaded from storage 135. Memory 120 may also include cache memory, such as a cache located the processor 110. In some embodiments, memory 120 may be distributed into different hardware modules 101-102.

In some embodiments, memory 120 stores a plurality of application modules 105-106. The application modules 105-106 contain particular instructions to be executed by the processor 110. Memory 120 can store any number of application modules. An application module 105-106 can be, for example, a calendar application, a geo-fencing application, a power management application, a smart alert application, a social media application (e.g., Twitter™ or Facebook™), or any application-type module having instructions to be executed by the processor 110.

It should be appreciated that embodiments of the invention as will be hereinafter described may be implemented in conjunction with the execution of instructions by the processor 110 of the device 100 and/or other circuitry of the device 100. Particularly, circuitry of the device 100, including but not limited to the processor 110, may operate under the control of a program, routine, or the execution of instructions to execute methods or processes in accordance with embodiments of the invention. For example, an application module 105-106 may be implemented in firmware, software or hardware and may be executed by the processor 110 and/or other circuitry of the device 100. Further, it should be appreciated that the terms processor, microprocessor, circuitry, controller, etc., refer to any type of logic or circuitry capable of executing logic, commands, instructions, software, firmware, functionality and the like. It is also to be noted that the function(s) of the processor 110 could be distributed across many different submodules and subsystems and does not necessarily have to fully be done in one physical entity.

In some embodiments, memory 120 includes an operating system 123. The operating system 123 may be operable to initiate the execution of the instructions provided by the application modules 105-106, manage the hardware modules 101-102 and/or manage the display module 103 and the user input module 104. The operating system 123 may be adapted to perform other operations across the components of the device 100 including threading, resource management, data storage control and other similar functionality.

In some embodiments, the portable electronic device 100 includes a plurality of hardware modules 101-102. Each of the hardware modules 101-102 is a physical module within the device 100. However, while each of the hardware modules 101-102 is permanently configured as a structure, a hardware module 101-102 may be temporarily configured to perform specific functions or temporarily activated. A common example is an application module that may program a camera module (i.e., a hardware module) for shutter release and image capture. A hardware module 101-102 can be, for example, an accelerometer, a Wi-Fi transceiver, a satellite navigation system receiver (e.g., a SPS module), a pressure module, a temperature module, an audio output and/or input module (e.g., a microphone), a camera module, a proximity sensor, an ambient light sensor (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module configured to provide sensory output and/or receive sensory input. In some embodiments, one or more functions of the hardware modules 101-102 may be implemented in software. In one embodiment, a hardware module 101-102 can be implemented as a subsystem that includes, for example, a processor to perform some operations, memory (e.g., a cache), and other components in addition to the sensor data (e.g., raw sensor output).

In addition to the hardware modules 101-102 and the application modules 105-106, the portable electronic device 100 may have a display module 103 and a user input module 104. The display module 103 graphically presents information from the device 100 to the user. This information may be derived from one or more application modules 105-106, one or more hardware modules 101-102, a combination thereof, or any other suitable means for resolving graphical content for the user (e.g., by operating system 123). The display module 103 can be liquid crystal display (LCD) technology, light emitting polymer display (LPD) technology, or other display technology. In some embodiments, the display module 103 is a capacitive or resistive touch screen and may be sensitive to haptic and/or tactile contact with a user. In such embodiments, the display module 103 can comprise a multi-touch-sensitive display.

The user input module 104 can be any means for accepting input from a user, such as a keyboard, track pad, a tactile button, physical switch, touch screen (e.g., a capacitive touch screen or a resistive touch screen), audio (e.g., via speech), camera (e.g., via tracking the location where the user looks at), or similar module. Thus, the user input module 104 may be distributed across a plurality of components. In embodiments in which the user input module 104 is provided as a touch screen, the user input module 104 can be integrated with the display module 103. In even another embodiment, the user input module 104 comprises both a touch screen interface and tactile buttons (e.g., a keyboard) and therefore is only partially integrated with the display module 103. The user input module 104 can provide user input to the application modules 105-106 (e.g., by changing a setting) and the hardware modules 101-102 (e.g., by causing the shutter release of a camera module). In some embodiments, the user input module 104 includes a microphone (not shown) so that user input may be received as sound (e.g., voice commands).

The portable electronic device 100 includes a rules engine platform 130 that is shown in this embodiment as a rules engine interface 131, a rules engine 132, a rules repository 133, and a knowledge repository 134. The rules engine platform 130 may be a computing platform that includes one or both of a hardware architecture and a software framework. In some embodiments, the rules engine platform 130 allows modules 101-106 to run by providing an architecture, one or more runtime system libraries, a graphical user interface and/or other components of a computing platform. For example, one or more components 131-134 of the rules engine platform 130 may be integrated with the operating system 123. In another embodiment, the rules engine platform 130 is a middleware platform that provides services to a module 101-106 beyond those available from the operating system 123. Services may include access to data (e.g., samples) or other functionality provided by another module 101-106 that is otherwise unavailable or restricted.

Though shown here as implemented in memory 120, the components 131-134 of the rules engine platform 130 are not necessarily tightly integrated and may be in fact separately implemented within the device 100. For example, the rules engine 132 may reside at an application-specific integrated circuit (ASIC) or at the processor 110 while the knowledge repository 134 resides in memory 120. Alternatively, the rules engine 132 may be divided into individual components distributed across the modules 101-106 and may have access to functionality and data associated with the modules 101-106. In some embodiments, one or more components 131-134 of the rules engine platform 130 are integrated. For example, some functionality of the rules engine interface 131 may be integrated with the rules engine 132 and other functionality may be integrated with a repository 133-134.

The rules engine interface 131 facilitates the interaction between the rules engine 132 and one or more of the modules 101-106. In many embodiments, communication between the modules 101-106 and the rules engine 132 is processed at this point. In some embodiments, the rules engine interface 131 provides an application programming interface (API), a dynamic link library (DLL), or other communicative resource that allows one or more of the modules 101-106 to send data to and/or receive data from the rules engine 132.

In some embodiments, the rules engine interface 131 adapts data received from a module 101-106 into a format interpretable by the rules engine 132. Data received at the rules engine interface 131 can be a sample, which may be any data associated with the sending module 101-106. Received samples may be stored, used to assert facts and/or derive contexts. The rules engine 132 may match facts to rules from a rule base so that rules are evaluated. The rules engine 132 may request a sample using the rules engine interface 131, e.g., the rules engine 132 may require an additional sample to evaluate a rule and may use the rules engine interface 131 to send the sample request and receive the sample as a response.

In some embodiments, the rules engine interface 131 is configured to subscribe to one or more modules 101-106 so one or more samples are received from the subscribed-to module 101-106. Subscribing to a module 101-106 may be in response to a request by the rules engine 132, such as a request for a sample. The rules engine interface 131 may also be configured to subscribe to a module 101-106 through an interface associated with the module, such as an API. The rules engine interface 131 may assert a fact based on a received sample and/or store the sample in a repository 133-134.

Broadly, asserting a fact refers to storing the fact in memory (e.g., memory 120 and/or storage 135) so that the fact can be used to identify and evaluate rules. For example, a fact may be asserted by storing that fact in the knowledge repository 134 in memory 120. Asserting a fact may cause the rules engine 132 to identify or evaluate one or more rules. In one embodiment, asserting a fact comprises verifying that a fact exists in memory 120 or is not stale. In some embodiments, asserting a fact may comprise determining the fact such that the fact can be used to identify and evaluate rules.

In subscribing to a module 101-106, the rules engine interface 131 may issue a single request for the sample (e.g., a single query) or may perpetually subscribe to the module 101-106 (e.g., polling or receiving a sample stream). In so doing, the rules engine platform 130 may monitor and manage one or more resources, for example by controlling when and/or how one or more modules 101-106 are queried and/or utilized. In some embodiments, the rules engine platform 130 may not passively wait for a module 101-106 to provide a sample, but rather may actively direct the performance of that module 101-106.

In some embodiments, the rules engine platform 130 is subscribed to by a module 101-106 through the rules engine interface 131. For example, a module 101-106 may subscribe to the rules engine platform 130 by requesting an action as a response. The rules engine interface 131 may translate some subscriptions into a format interpretable by the rules engine 132 so that the rules interface 131 can provide a meaningful response, such as where the rules engine 132 evaluates a rule to determine an action. As a feature of the rules engine platform 130, a respective one of the modules 101-106 requesting data about a second module 101-106 will send a request to the rules engine interface 131 and receive an action from the rules engine interface 131. In one embodiment, a module 101-106 is perpetually subscribed to the rules engine interface 131 as a result of being implemented within the device 100 having the rules engine platform 130.

The rules engine platform 130 may be configured to accept requests that update the rule base, such as requests to add a new rule or update or remove an existing rule. The rules engine interface 131 may be configured to translate a request for interpretation by the rules engine 132. Thus, in some embodiments the rules engine interface 131 includes or is coupled with a rules translator (not shown) that can be a compiler, interpreter or a similar resource for translating rules. The rules engine interface 131 may then update the rule base in the rules repository 133 according to the request so that the rules engine 132 may evaluate the updated rules. This translation at the rules engine interface 131 allows updates to the rule base to be implemented at runtime. Therefore, the rules engine platform 130 enables runtime customization, context awareness, smart services and similar features of the device 100.

A module 101-106 may provide updates for the rule base to the rules engine interface 131. For example, a user of the portable electronic device 100 may input rules through the user input module 104, such as a new rule accepted as vocal user input or touch user input. In some embodiments, a user can define a parameter through one of the modules 101-106 which creates, modifies or deletes a rule, such as where the user changes a setting of a module 101-106. In some embodiments, the user may input a rule written in a high-level language using the user input module 104.

The rules engine 132 may implement a RETE algorithm (e.g., a DROOLS rules engine) to evaluate a rule and determine an action. Succinctly, the rules engine 132 is configured to identify a condition (e.g., a fact or set of facts asserted from one or more samples) and match a rule. In many embodiments, a rule defines a conditional relationship between a condition and a result. This relationship is often colloquially referred to as an “if-then statement,” and may take the form of “if [condition] then [result].” The rules engine 132 may dynamically select or identify one or more rules for evaluation from the rules repository 133 at runtime. Additionally, the rules engine 132 may cache rules, such as frequently evaluated or anticipated rules, to reduce the duration of access and evaluation. The rules engine 132 may determine an action from the result of evaluating a rule or the result may be an action. Accordingly, the rules engine 132 may be declarative and advantageously separate data (e.g., a sample used to assert a fact) from the logic (e.g., a rule) within the portable electronic device 100.

The rules engine 132 may organize the rules and facts for efficient evaluation. In some embodiments, the rules engine 132 may construct an organizational structure based on some or all of the rules defined in the rules repository 133. The rules engine 132 may store this organizational structure in the knowledge repository 134. An organizational structure may be similar to a directed graph or trie (i.e., a prefix tree). The rules engine 132 may decompose a rule into its components, e.g., a complex rule requiring multiple facts may be decomposed into one or more requirements that can be quickly and efficiently evaluated by accessing the organizational structure. The rules engine 132 can provide indexing and hashing in accordance with the organizational structure to optimize evaluation performance. For example, the rules engine 132 can hash facts in the organizational structure to efficiently evaluate one or more rules. The rules engine 132 may also optimize rule evaluation by identifying and collapsing identical requirements of the organizational structure so that requirements may be shared. The rules engine 132 therefore may be configured to provide an action to a module by accessing the organizational structure. The rules engine platform 130 can optimize performance of the portable electronic device 100 by increasing efficiency, increasing speed, decreasing power consumption, decreasing system resource consumption, and/or affecting similar attributes that are intended to enhance the performance of the portable electronic device 100. Therefore, “optimization” does not necessarily mean “the best” or that there is only one resulting effect/possibility of the rules engine platform 130. Thus, the rules engine platform 130 is not required to maximize efficiency or minimize power consumption, but may improve these aspects. For example, the rules engine platform 130 may increase speed while simultaneously increasing power consumption and these increases may be considered optimal in certain embodiments because power consumption may not immediately be a concern in some such embodiments where increased speed is desirable. In certain embodiments, the rules engine platform 130 provides an interface (e.g., through the rules engine interface 131) to a user that is implementing the rules engine platform 130 in the portable electronic device 100 so that optimization settings or parameters for speed, power and other such attributes (e.g., a tradeoff value between speed and power) can be manually set or calibrated.

Accordingly, the rules engine 132 may enhance power savings and performance (e.g., processing speed) by receiving one or more samples and providing one or more actions within the portable electronic device 100, thereby minimizing the transmission of data directly between the modules 101-106. In the embodiment shown in FIG. 1, the modules 101-106 subscribe to the rules engine platform 130 so that actions are determined by the rules engine 132 and sent through the rules engine interface 131. Advantageously, one of the modules 101-106 may no longer need to subscribe to or make requests to another one of modules 101-106. For example, two of the modules 101-106 may require the location of the portable electronic device 100. The location of the device 100 may be received as a sample and asserted as a location fact. Both modules requiring the location may only need to request the location from the rules engine 132 (through the rules engine interface 131), and the rules engine 132 may quickly access the location fact to provide the location to each requesting module (e.g., as an action through the rules engine interface 131). Consequently, a satellite positioning system (SPS) module (e.g., a hardware module of the modules 101-102) does not need to detect the current location twice and then send the current location twice (once for each requesting module). Additionally, the rules engine platform 130 provides scalability to handle a number of rules and a number of modules 101-106 subscribing thereto.

In some embodiments, the rules engine 132 may evaluate a rule to true but determine that an action is to do nothing. Therefore, the rules engine 132 may not necessarily provide an action to the rules engine interface 131 or may provide a null action so that the rules engine interface 131 does not send out any action. The rules engine 132 may also determine that an action may be a response to do nothing. The rules engine interface 131 may then provide the response to do nothing to a receiving module 101-106 or may provide a null value to the receiving module 101-106.

As a supplementary component of the rules engine platform 130, the rules repository 133 is configured to suitably store a rule base—that is, the rules which the rules engine 132 may evaluate. The rules repository 133 may be distributed across storage 135 and memory 120 at runtime. In other embodiments, the rules repository 133 may be distributed across the processor 110 and/or may be divided into individual components distributed across the modules 101-106 and/or may have access to functionality and data associated with the modules 101-106. In addition to rules, the rules repository 133 may also store templates, variables, parameters, and other information required for the rules engine 132 to determine an action and/or effect a determined action. The rules repository 133 is configured to accept updates to the rule base, such as added, updated or deleted rules. For example, a module 101-106 may request an update to the rule base in response to user input.

In addition to the rules repository, the rule execution could also be distributed across the processor 110 and the different modules 101-106. For example, the knowledge base 134 may be distributed across the processor 110 and/or may be divided into individual components distributed across the modules 101-106 and/or may have access to functionality and data associated with the modules 101-106.

In some embodiments, a rule base may be dynamically organized at runtime into a plurality of sets or into one or more hierarchies and the rules engine 132 may selectively evaluate one or more of the sets or levels of the hierarchies. For example, when a fact indicates that the user is at home, the rules engine 132 may evaluate rules that apply when the user is at home and/or may omit evaluation of rules that apply when the user is at work. Where the rules engine 132 evaluates a rule to true, the rules engine 132 determines an action. Subsequently, the rules engine 132 may provide the action to the rules engine interface 131 so that the action can be sent to a receiving module 101-106 or the action may be asserted as a fact that causes additional rules to evaluate to true.

The rule base stored in the rules repository 133 may be dynamically updated at runtime, such as by receiving new rules or automatically creating rules. Furthermore, the rules repository 133 may accept updates to the rule base to support context awareness of the device 100. The rules repository 133 may also accept rules from a remote source. For example, rule updates may be loaded from a file (e.g., a binary file from an SD card), a uniform resource identifier (URI) (e.g., binary rules from a server or from the cloud), or an asset (e.g., an asset loaded from an asset directory). These rule updates may be precompiled or may be compiled by a rules translator (not shown).

In some embodiments, the rules engine platform 130 further includes a knowledge repository 134. The knowledge repository 134 may be included in the memory 120, such as RAM. It should be appreciated that the knowledge repository 134 can be distributed in caches or buffers, such as a cache at the processor 110, in addition to memory 120. The knowledge repository 134 may store a fact base—that is, facts that the rules engine 132 may use to evaluate rules. The fact base may be part of an organizational structure constructed by the rules engine 132. In one embodiment, facts include unprocessed, raw data such as sensor (e.g., accelerometer, camera, audio, etc) samples from a module 101-106 or processed pieces of information (e.g., motion state that could be one among walking, driving, running, at rest, flying, etc) from a module 101-106. A fact may be a data tuple of zero (e.g., null) or more data objects that is asserted in the knowledge repository 134 from a sample received from one or more of modules 101-106, an inference, an expected sample (e.g., a sample that has not yet been received), a context, another rule (e.g., an action or a result) or any other data that is monitorable by the rules engine 132.

In one embodiment, one or more facts are asserted to defaults (e.g., null or false), such as where the rules engine 132 is initialized or where no samples have been received. The fact base in the knowledge repository 134 may be dynamically updated at runtime. For example, facts asserted from outdated samples may be updated with a current sample, updated from a default value or new facts may be asserted from new samples. In response to updates to the fact base, the rules engine 132 may identify and/or evaluate rules in the rules repository 133. In one embodiment, the rules engine 132 may only assert a fact where a received sample substantively affects the fact. For example, a stored location fact does not need to be repeatedly asserted for newly received location samples if the location remains the same.

In one embodiment, the rules engine 132 examines one or more facts or samples to make inferences and may assert those inferences as facts in the knowledge repository 134. For example, the rules engine 132 may receive a location sample indicating that the user is at work and, using facts indicating that the user is not scheduled to be in a meeting and is not in motion, assert a fact that the user is available at work. The location sample may be individually asserted as a fact, stored or discarded.

Additionally, the rules engine 132 may store contexts in the knowledge repository 134. A context is generally understood as the environment or circumstance of the device 100 or a user of the device 100. Illustratively, a context may be that the user of device 100 is in a meeting, in a discussion, on a call, near a geo-fence, near a person, at home, driving, and the like. A context may be a collection of contextual or anticipatory information, such as a context that the user of the device 100 is currently driving and approaching a geo-fence. In one embodiment, the rules engine 132 determines a context by making an inference from one or more samples or facts. Alternatively, the rules engine 132 may receive a context as a sample from a module 101-106, such as a context awareness module. The rules engine 132 may assert a fact from a context and/or may organize and evaluate facts and rules based on a context.

In some embodiments, the rules engine platform 130 supports smart services, such as by processing one or more samples, facts, or rules to derive the intentions, conditions or environments of a user of the device 100 without explicit definitions. For example, a module 101-106 may request the addition of a rule without providing explicit conditions that cause the rule to evaluate to true. The rules engine platform 130 may translate a rule having indeterminate or fuzzy conditions into an evaluable rule. Illustratively, an intelligent personal assistant application module 105 may request the addition of a new rule pursuant to user input: “notify the user on a friend's birthday.” The rules engine platform 130 may translate the rule by requesting a sample from a contacts/address book application module 106 that includes the calendar date of the friend's birthday (e.g., December 20). Using that sample, a well-defined rule may be added to the rules repository 133: “if the date is December 20, notify the user that today is the friend's birthday.” In another example, an application module 105 requests the addition of a new rule: “notify the user to buy groceries.” The rules engine platform 130 may translate this rule by resolving a context related to the rule, such as a geo-fence that includes a grocery store. Using that sample, the rules engine interface 131 may add a well-defined rule to the rules repository 133: “if the user is near the geo-fence, notify the user to buy groceries.” Later, when a sample is received indicating the user's location is near or within the geo-fence, the rules engine 132 determines an action to notify the user to buy groceries.

In some embodiments, one or both of the repositories 133-134 acts as a repository for asset management of knowledge and deployment. The repository could be centralized in one physical entity or distributed across various hardware modules and subsystems. This asset management can include access control policies specifying permissions for a module 101-106 to access data and other similar constraints. A repository 133-134 may also maintain metadata associated with the rules and/or facts, such as how one or more of the modules 101-106 are associated with the rules (e.g., a list of modules 101-106 subscribing to the rules engine platform 130 and/or a list of modules 101-106 from which a sample is required to assert a fact). In one embodiment, a repository 133-134 stores data that is not asserted as facts, such as received samples or past contexts. For example, a location sample may not be used to assert a fact, but may be required for a rule that results in sending the location sample to a module 101-106. Likewise, contexts may be stored so that the rules engine 132 or a context awareness engine (not shown) may derive relationships between contexts or anticipate future contexts.

The implementation of the rules engine 132 as a platform 130 may allow the rules engine 132 to provide provenance information from information stored at a repository 133-134. The rules engine platform 130 may provide provenance information to the user at the display module 103 or may provide provenance information to a module 101-106 adapted to monitor such information. In one embodiment, provenance information may include information related to the evaluation of a rule and a corresponding determination of an action. Such provenance information may include information about a fact that caused a rule to be evaluated or a module 101-106 that provided a sample for asserting the fact.

In some embodiments, the rules engine 132 is configured to store information related to provenance at a repository 133-134. For example, the rules engine 132 may store the time a rule was evaluated, the condition (e.g., facts) that caused a rule to be evaluated, the action that was determined from the rule's evaluation, a prior rule that caused the rule to evaluate to true, or other related information. In some embodiments, the rules engine 132 traces information related to the modules 101-106, such as a module 101-106 that received an action or a module 101-106 that provided a sample for which a fact was asserted. For example, a news report notification may be displayed on the display module 103 pursuant to a sample provided by a Rich Site Summary (RSS) application module 105-106. The notification may be supplemented with provenance information about the RSS application module 105-106, such as an identification of the RSS application module 105-106 or an indication that the news report is tagged with a category of interest to the user.

In one embodiment, the rules engine 132 stores information related to the activity of a module 101-106. A module 101-106 that sends a large number of samples or receives a large number of actions will generally consume a greater amount of resources than a module that is less active. The rules engine 132 may derive activity information or usage statistics about a module 101-106 from stored information, such as the power consumption, the effect on the processor 110 load, the effect on another module (e.g., an email application module 105-106 may increase the activity of a cellular transceiver module 101-102 by polling for new email messages), or other resource consumption.

Accordingly, the rules engine 132 may monitor a module 101-106 such as by tracking the frequency or quantity of actions sent to the module 101-106, the evaluations of a rule for the module 101-106, or the facts asserted from samples provided by the module 101-106. For example, a location-based social-networking application module 105-106 (e.g., Foursquare™) may add a rule “if this application module is running, then send the current location to this application.” Such a rule may perpetually evaluate to true and, consequently, cause a large amount of resources to be consumed while the application module 105-106 is running. The rules engine 132 may store information related to the resource consumption of the application module 105-106, such as the power consumption or the effect on the processor 110 or a SPS sensor module 101-102. From stored information, the rules engine 132 may determine usage information about a module 101-106, such as a module that is expensive for the device 100.

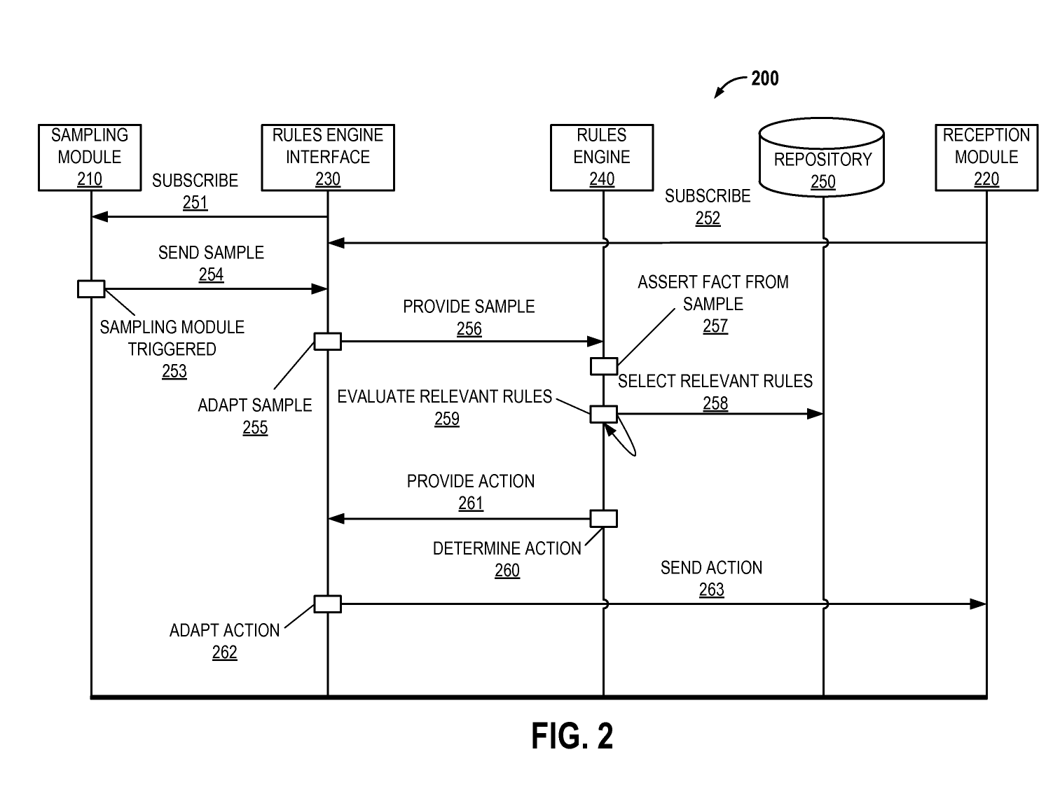

FIG. 2 shows a sequence 200 for providing a rules engine platform within a portable electronic device. In some embodiments, the operations of the sequence 200 may be transposed or contemporaneous. The illustrated sequence can be performed within an embodiment of the portable electronic device 100 of FIG. 1. Accordingly, the rules engine interface 230 can be or can include the rules engine interface 131, the rules engine 240 can be or can include the rules engine 132 and the repository 250 can be or can include one or both of the rules repository 133 and knowledge repository 134.

In FIG. 1, the modules 101-106 are represented abstractly to indicate each of the modules may be configured to perform conceptually similar functionality. This functionality may be sending data to or receiving data from the rules engine platform 130. According to FIG. 2, the sampling module 210 and the reception module 220 can be or can include any of the modules 101-106, respectively, shown in FIG. 1. In some embodiments, the sampling module 210 and the reception module 220 are the same module.

A module 101-106 can send data associated with the module 101-106 and this sent data may be interpreted as a sample for the respective module 101-106. Thus, the sampling module 210 may be any module 101-106 that is configured to send a sample. A sample may be raw input data from a sensor module (e.g., a voltage from a gyroscope), processed data from a sensor module (e.g., a cardinal or ordinal direction from a magnetometer), data from an application module (e.g., a notification from a messaging application), or any other data that may be provided by a module 101-106. In many embodiments, the rules engine interface 230 subscribes to the sampling module 210 before a sample is sent.

Illustratively, in an embodiment in which the hardware module 101 is an inertial sensor, the hardware module 101 can send a sample that includes a measured orientation or a sample that is an indication that the measured orientation has changed beyond a threshold amount. Analogously, in an embodiment in which the application module 105 is a messaging application, the application module 105 can send a sample that includes an indication that a new message has been received or a sample that includes the text of the new message. In both examples, the modules 101 and 105 operate as the sampling module 210. Accordingly, many of the modules 101-106 may simultaneously act as sampling modules. The sampling module 210 can send a sample to the rules engine interface 230 in response to a request or an event (e.g., at a predetermined time), or the sample may be unsolicited.

Similar to sending a sample, a module 101-106 can receive data, such as an action. A module 101-106 configured to receive an action may be the reception module 220. For example, in an embodiment in which the hardware module 101 is a camera module, the hardware module 101 can receive an action that includes a command to release the shutter. Analogously, in an embodiment in which the application module 105 is a calendar application, the application module 105 can receive an action to add a new event to the calendar. In both examples, the modules 101 and 105 operate as the reception module 220. Accordingly, many of the modules 101-106 may simultaneously operate as reception modules. In many embodiments, the reception module 220 subscribes to the rules engine interface 230 before an action is sent.

In one embodiment, the sequence 200 begins where the rules engine interface 230 subscribes to or monitors the sampling module 210 (operation 251). This subscription can be in response to a request from the rules engine 240. In subscribing to or monitoring the sampling module 210, the rules engine interface 230 can receive one or more samples from the sampling module 210. In one embodiment, the subscription can be a solitary request by the rules engine interface 230 for a sample from the sampling module 210. In other embodiments, the rules engine interface 230 can perpetually subscribe to the sampling module 210, such as by polling, receiving a stream of samples or repeatedly querying the sampling module 210 for one or more samples. The rules engine interface 230 may also be configured to perpetually subscribe to the sampling module 210 through an interface associated with the sampling module 210 (e.g., an API).

A subscription by the rules engine interface 230 to the sampling module 210 may vary according to the embodiment. In some embodiments, the rules engine interface 230 can have more than one subscription to the sampling module 210 so that different samples are provided for different subscriptions. For example, in an embodiment wherein the sampling module 210 is a messaging application, the rules engine interface 230 can subscribe to the sampling module 210 so that the sampling module 210 provides samples that include the subject or body of a message. Alternatively, the rules engine interface 230 can subscribe to the sampling module 210 so that a sample is simply a notification that a new message has been received at the sampling module 210. Importantly, the rules engine interface 230 may concurrently subscribe to a plurality of sampling modules including the sampling module 210.

Also as part of the sequence 200, a reception module 220 subscribes to the rules engine interface 230 (operation 252). The reception module 220 can subscribe to one or more actions that the rules engine interface 230 is configured to send. For example, the reception module 220 may update the rule base to include a rule that results in an action for the reception module 220 or the reception module 220 may make a specific call to the rules engine interface 230. Also, the reception module 220 may generically subscribe to the rules engine interface 230. In one embodiment, the subscription can be a solitary request for an action from the rules engine interface 230. In other embodiments, the reception module 220 can perpetually subscribe to one or more actions provided by the rules engine interface 230.

In an illustrative embodiment, the reception module 220 is an application that notifies a user (e.g., presents a notification on a display) based on a geo-fence. In such an embodiment, the reception module 220 subscribes to a geo-fence action provided by the rules engine interface 230 so that the reception module 220 is provided the geo-fence action by the rules engine interface 230 when the device performing the sequence 200 crosses a geo-fence perimeter.

In one embodiment, the reception module 220 is automatically subscribed to one or more actions provided by the rules engine interface 230. This automatic subscription may be a consequence of being implemented in a portable electronic device having a rules engine platform. In such embodiments, the rules engine 240 may broadcast an action through the rules engine interface 230 (e.g., across a common messaging bus) and the reception module 220 is configured to receive that action (e.g., the action may be received by the reception module 220 contemporaneously with one or more other modules).

In many embodiments, the sampling module 210 may be triggered so that a sample is produced (operation 253). For example, an inertial sensor sampling module 210 may be triggered where the device performing the sequence 200 has changed orientation with respect to a particular axis. The detected change in orientation may trigger the inertial sensor sampling module 210 to send the sample. In some embodiments, the sampling module 210 may be perpetually triggered, such as where the sampling module produces a continuous stream of samples. In another embodiment, the sampling module 210 may be triggered to produce a sample in response to a subscription by the rules engine interface 230 (e.g., the sampling module may be triggered to provide response to a query from the rules engine interface 230).

Where the sampling module 210 is triggered to produce a sample, the sampling module 210 is configured to send or provide the sample to the rules engine interface 230 (operation 254). In many embodiments, the sample sent by the sampling module 210 to the rules engine interface 230 is in accordance with the subscription of the rules engine interface 230 to the sampling module 210 (operation 251).

In some embodiments, a sample received from the sampling module 210 (operation 254) is not suitable for interpretation by the rules engine 240. Accordingly, the rules engine interface 230 is configured to adapt the sample to a format interpretable by the rules engine 240 (operation 255). Adapting the sample can be accomplished by the rules engine interface 230. For example, the rules engine interface 230 may unmarshal the sample. In other embodiments, the rules engine interface 230 operates with one or more additional components, such as a rules engine adapter (not shown), to adapt the sample for the rules engine 240.

In some other embodiments, rules engine 240 may include an API which provides a sample to the rules engine 240 at a predetermined rate. By means of an example, a user input module (e.g., a module 210, 220) may accept input from a user that specifies that the location of the portable electronic device is to be updated every 10 minutes or emails are to be downloaded by a module (e.g., a module 210, 220) at a maximum periodicity of every two minutes. The rules engine 240 may specify the sampling rates of the sampling module 210 according to the input from the user. An API included in the rules engine interface may allow a user interface module (e.g., a module 210 or 220) to make this modification to the sampling rate of the sample module 210.

In certain embodiments, the rules engine 240 may be configured to handle possible conflicting requirements obtained from different applications. For example, consider the case wherein a social application running on the device requires the location to be updated every 10 minutes and a weather application requires location fix every 6 minutes. The rules engine 240 may adapt the sampling rate accordingly so as to meet the demands of the two applications and reuse the location fixes across applications in order to reduce power in some such embodiments.

Note that the part of the rules engine that modulates the sampling of the sensor may physically reside in a centralized unit or could be distributed across to the individual subsystems in the device.

Having suitably adapted the sample, the rules engine interface 230 is configured to provide the adapted sample to the rules engine 240 (operation 256). In some embodiments, the sample is provided in response to a request from the rules engine 240. The rules engine interface 230 may also provide the sample to the rules engine 240 pursuant to a subscription from the reception module 220 (operation 252). In some embodiments, the sample is added to a set of samples, which may be received from additional sampling modules (e.g., received samples stored at the repository 250). A full set or partial set of samples may then be provided to the rules engine 240.

In some embodiments, the rules engine 240 asserts a fact to be used for the evaluation of one or more rules (operation 257), such as by adding or updating a fact. The rules engine 240 may assert the fact by storing the sample, such as in the repository 250 or in other memory. Alternatively, the fact may be asserted from an inference derived from the sample and one or more other facts or samples. In other embodiments, the rules engine 240 asserts the fact based a rule or an expected sample (e.g., the absence of a sample). According to one embodiment, the rules engine 240 constructs an organizational structure based on some or all of the rules defined in the repository 250. In response to one or more samples, the rules engine 240 can update the organizational structure by asserting a fact. Importantly, a fact may be asserted following different operations of the sequence 200, beyond just where a sample is provided. For example, the evaluation of a rule (operation 259) and/or the determination of an action (operation 260) may cause a fact to be asserted (operation 257). In some embodiments, the sequence 200 resumes by selecting and evaluating relevant rules (operations 258-259) and determining an action (operation 260) where a fact has been asserted (operation 257) from the evaluation of a rule or the determination of an action.

The rules engine 240 is configured to select or identify one or more relevant rules for the asserted fact (operation 258). The rules engine 240 may select one or more relevant rules from the repository 250. In some embodiments, a rule defines a conditional relationship between at least one fact and an action. Therefore, the rules engine 240 selects or identifies one or more rules wherein the fact fulfills all or part of the condition. In selecting a relevant rule, the rules engine 240 may also select additional assets. In some embodiments, assets include metadata associating the rule with a particular module (e.g., the sampling module 210 and/or the reception module 220). Assets may also comprise one or more access control lists for permissions associated with certain rules.

The selection or identification of one or more relevant rules may not be an actual request or query to the repository 250 for a rule. In some embodiments, the rules engine 240 identifies a relevant rule that has already been selected from the repository 250. For example, the rules engine 240 may cache a relevant rule based on a context in anticipation of evaluation.

With the relevant rules selected, the rules engine 240 evaluates the relevant rules for the asserted fact (operation 259). Importantly, the rule execution process by the rules engine 240 may be complex and require multiple samples (or the absence of one or more samples) asserted as facts to evaluate a rule. For example, to evaluate the rule “if the user of the portable electronic device is in a meeting, then disable audio notifications,” the rules engine 240 may receive a sample from a calendar sampling module that the user is scheduled to be in a meeting as well as a sample from a SPS (or Wi-Fi) sampling module that the device is within a geo-fence that includes the meeting location (or room). The rules engine 240 may assert these two samples as separate facts, or as one fact indicating that the user is “in a meeting.” In response to the asserted fact(s), audio notifications are disabled. Additionally, the rules engine 240 is configured to maintain received samples asserted as facts for evaluating rules at a later time.

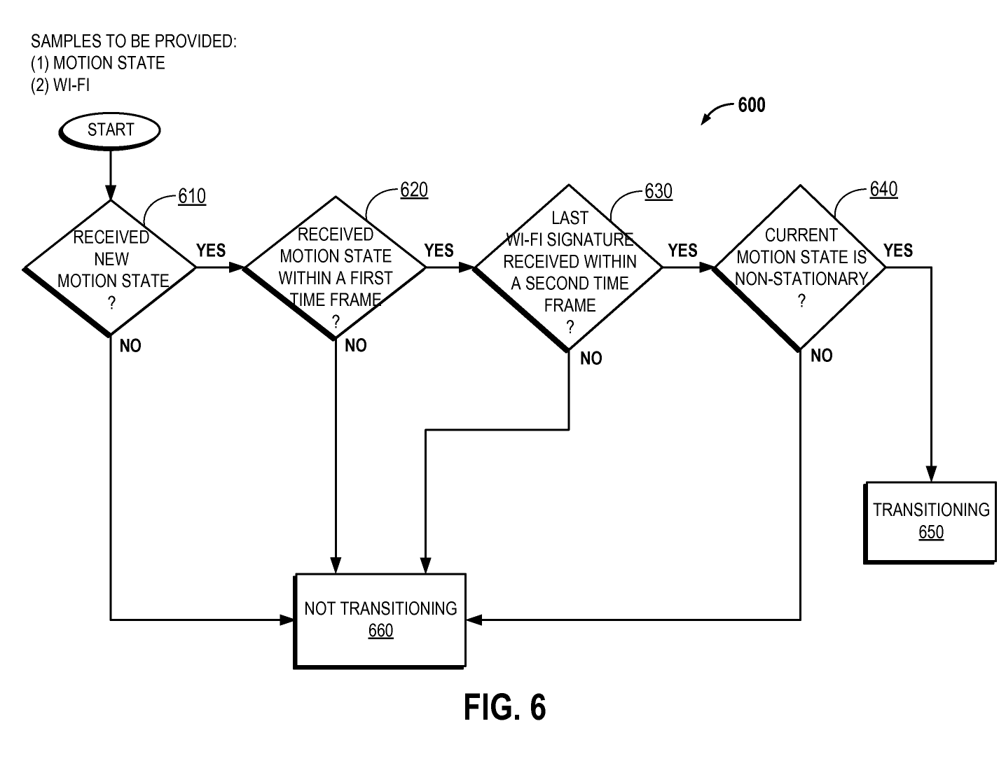

The evaluation of one rule by the rules engine 240 may mandate the evaluation of a second rule. Identifying and selecting one or more additional rules can be done in response to evaluating a preceding rule or set of rules. The rules engine 240 may also require additional facts to evaluate a rule and determine an action (an exemplary fact asserted from an inference is shown in FIG. 6). For example, where a Bluetooth sampling module 210 sends a sample indicating that the portable electronic device is paired with the audio system of the user's car, the rules engine 240 can assert a fact that the user is in the car. However, the rules engine 240 may not assert a fact that the user is driving until location samples are received indicating that the user is moving or the accelerometer samples indicate movement at a speed expected of a vehicle (i.e., not slow at walking speed and not fast at the speed of airplane). Thereafter, the rules engine 240 may evaluate a rule for an asserted fact that the user is driving. The driving rule may cause touch input to be disabled for text messaging and, accordingly, the rules engine 240 may assert a fact that causes a rule to be evaluated to enable speech input for text messaging.

Where the rules engine 240 has evaluated the one or more relevant rules to true, the rules engine 240 is configured to determine an action according to the relevant rule(s) (operation 260). The action may be determined from the result of evaluating the relevant rule to true. In many embodiments, the determined action is the result of the rule.

In one embodiment, the rules engine 240 may determine that the action is to do nothing. In response, the rules engine 240 may not provide an action to the rules engine interface 230 or may provide a null action so that the rules engine interface 230 does not send out any action. The rules engine 240 may also determine that an action may be a response to take no action. The rules engine interface 230 may then provide the response to take no action to the reception module 220 (e.g., as a message or by returning a null value).

In other embodiments, metadata selected from the repository 250 supplements the action. For example, where the rules engine 240 evaluates a relevant rule to true for a fact that a new message has been received at the sampling module 210, the metadata may prescribe whether the determined action is to send the text of the message or, alternatively, a notification that a new message has been received. Metadata can also indicate an identification of the reception module 220 within the portable electronic device that is to be notified according to a determined action. Metadata may also include supplementary parameters such as temporal or behavioral parameters. In some embodiments, metadata is included with the determined action so that the reception module 220 is able to identify the sampling module 210 or a particular rule that triggered the sending of the determined action to the reception module 220.

Subsequently, the rules engine 240 provides the determined action to the rules engine interface 230 (operation 261). The rules engine interface 230 is then configured to adapt the determined action to a format suitable for transmission to and reception by the reception module 220 (operation 262). In other embodiments, the rules engine interface 230 operates with one or more additional components, such as a rules engine adapter, to adapt the action for the reception module 220. In one embodiment, the rules engine interface 230 may marshal the determined action. Other suitable adaption techniques may be used by the rules engine interface 230, such as serialization.

The rules engine interface 230 then sends the determined action to the reception module 220 (operation 263). In one embodiment, the identification of the reception module 220 is provided by the rules engine 240 (e.g., through metadata associated with one or more rules). In some embodiments, the rules engine interface 230 may broadcast the determined action (e.g., across a common messaging bus) and the reception module 220 may receive the action from the broadcast. Thus, the reception module 220 does not have to be specifically identified or targeted when sending the determined action. The reception module 220 handles the determined action in accordance with the embodiment of the reception module 220.

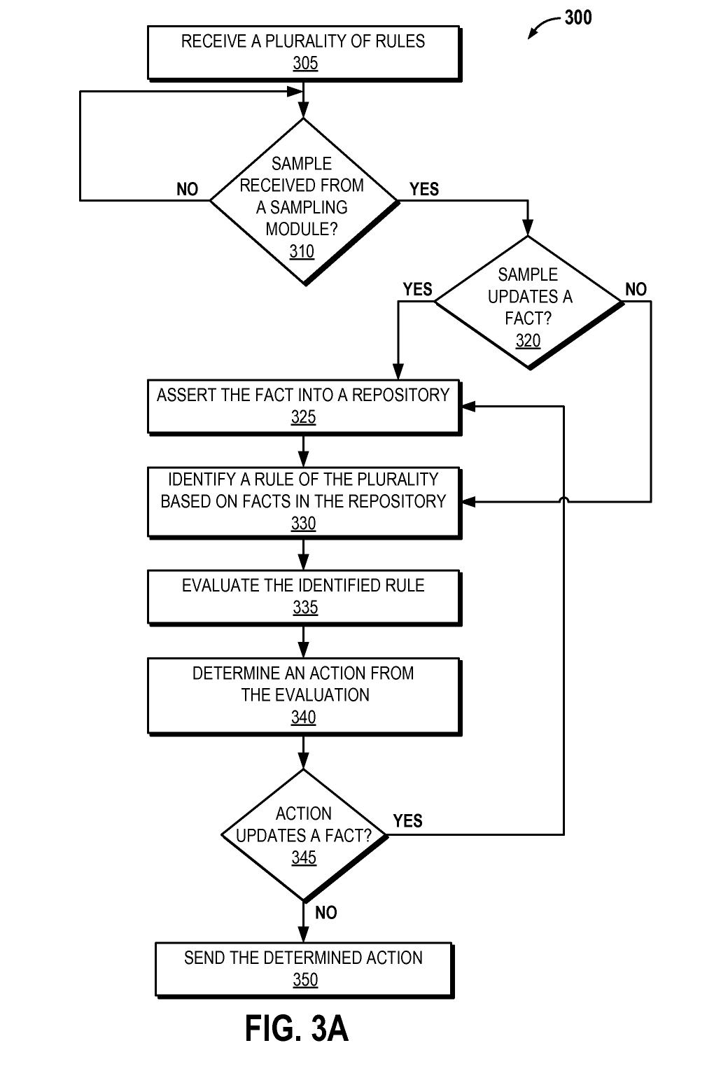

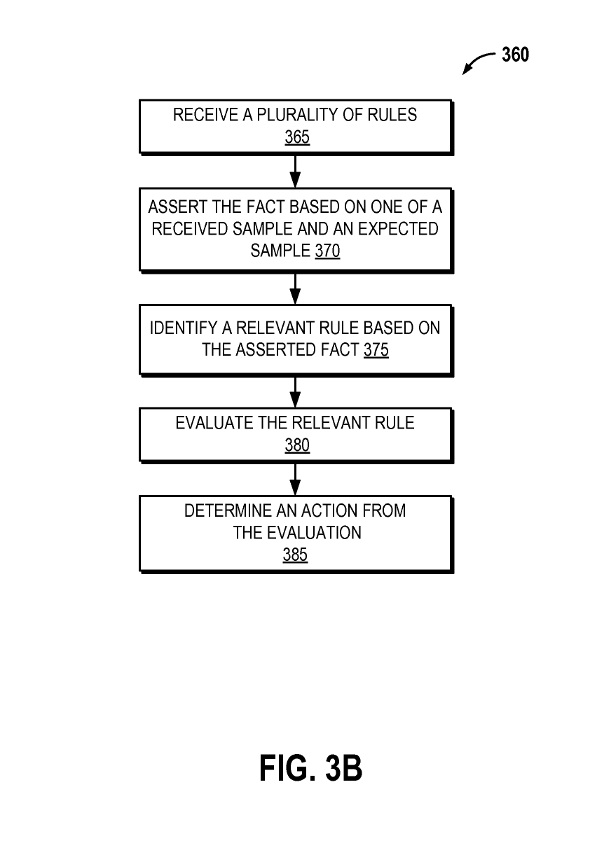

FIG. 3A shows an example of a method 300 performed by a rules engine platform within a portable electronic device according to one embodiment of the invention. The operations of FIG. 3A are illustrative and are not necessarily performed in the order depicted. The method 300 can be performed by the rules engine platform 130 of portable electronic device 100 shown at FIG. 1; for example, operations can be performed by the rules engine interface 131 and/or the rules engine 132. The rules engine platform executing the method 300 can be communicatively coupled with other components of a device in which it is implemented, such as modules and a processor. In one embodiment, the rules engine platform may be divided into individual components that are distributed across hardware, storage, processor(s), modules or other components of the portable electronic device. The rules engine platform may have access to functionality and data associated with such components.

Initially, the rules engine platform receives a plurality of rules which may influence or govern the behavior of one or more modules communicatively coupled with the rules engine platform (operation 305). Rules may be dynamically received at runtime from a module communicatively coupled with the rules engine platform (e.g., a module 101-106), from a remote source (e.g., the cloud or a URI), or from a local source (e.g., a directory in memory or removable flash memory device) however rules may also be predefined (e.g., received at compile time of the rules engine platform). The received rules may update an existing rule base stored in a rules repository (e.g., rules repository 133) or may be received at design time or other compile time of the rules repository. In one embodiment, the plurality of rules may be received in response to a request from the rules engine platform, such as a query.

The rules engine platform may construct an organizational structure in response to the received plurality of rules. The organizational structure may indicate a start state where the rules engine platform is newly initialized. In one embodiment, the organizational structure includes a number of facts that cause a rule to evaluate to true. The facts may initially be asserted to a default, such as null or false. The rules engine platform may also receive a plurality of rules that updates an existing organizational structure. The rules engine platform is then configured to update the existing organizational structure to incorporate the plurality of received rules, for example, by modifying existing requirements, removing obsolete requirements and identifying newly shared requirements.

In addition to the plurality of rules, the rules engine platform performing the method 300 is configured to receive at least one sample from at least one sampling module, such as a module 101-106 of FIG. 1 (decision block 310). However, samples may not be received in all instances. For example, a sample may not be received where the rules engine platform has not queried a module or where a sample stream provided by a module is not present. The rules engine platform, however, may determine the samples to be received from the sampling modules based on, for example, a subscription to the sampling module. In one embodiment, the rules engine platform may determine the samples to be received based on the organizational structure—e.g., the rules engine platform may decompose the rules to identify required facts for constructing the organizational structure and, in so doing, determine the samples from which the required facts may be asserted.

Where a sample is received, the rules engine platform performing the method 300 may determine if the sample indicates that a fact is to be updated (decision block 320). A fact may be updated to reflect the current state of the device implementing the rules engine platform, such as where a received sample indicates new data (e.g., a new message) or a change in the environment (e.g., a new context). For example, a new message fact may be updated where a new message sample is received from a social networking module. Additionally, a fact may be updated where the sample modifies the fact as a whole, even where other constituent components (e.g., facts or samples) of the fact remain valid. For example, a combination of samples or facts (e.g., an inference) may cause the fact to be asserted that the user is sleeping; however, receiving a motion state sample indicating that the user is moving may require the fact to be updated to indicate that the user is not sleeping.

As appropriate, a fact is asserted in a repository (e.g., a repository 133, 134) pursuant to sample reception (operation 325). In one embodiment, the fact is only asserted where a sample or the absence thereof substantively updates the facts (e.g., changes the truth value of a fact). The fact may be asserted in the repository by being stored in memory, such as RAM, cache memory, a buffer, or a combination of memory locations for instant access as well as future access. The fact may be asserted as a combination of samples or facts (e.g., an inference), which may already be stored in the repository. In one embodiment, the fact is asserted by updating the organizational structure to reflect the update. Additionally, the fact may be added to persistent storage, such as non-volatile memory.

In some embodiments, a plurality of facts may be asserted pursuant to sample reception—i.e., a received sample or the absence thereof may necessitate the contemporaneous update of more than one fact. Particularly, this may be the case for a fact that is asserted from one sample and one or more facts that are asserted from a plurality of samples or facts that includes the one sample.

In accordance with facts in the repository, the rules engine platform performing the method 300 is configured to identify one or more rules (operation 330). As illustrated, the rules engine platform may identify a rule in response to the asserted fact (e.g., where the asserted fact is required to satisfy the rule's condition). Alternatively, a rule may be identified where no facts are updated, such as at the initialization of the rules engine platform or where rules are to be identified at a specific time (e.g., according to a clock signal). A rule can be identified and subsequently selected from a rules repository, such as where the rules engine 132 selects a rule from the rules repository 133. However, the rule may not be immediately evaluated, but may be buffered or cached to expedite evaluation when an additional fact is asserted that causes the rule to evaluate to true.

In some embodiments, a rule is identified in accordance with a conflict resolution agenda, such as a hierarchy of rules or a salience attribute of the rule in relation to other rules. Identifying a rule according to a conflict resolution agenda may reduce the occurrence of instances wherein a plurality of rules may be relevant to the facts in the repository but have conflicting results when evaluated to true. Further, a rule may be identified pursuant to a context. Consequently, rules that may be relevant to the facts in the repository but are irrelevant to a context of interest (e.g., the instant context, an anticipated context or a frequent context) may be bypassed in favor of identifying a rule that is relevant to the context of interest.

In certain embodiments, each rule has an associated weight suggesting the importance of the rule. For example, a rule with a higher weight implies that it takes precedence over a rule with a lower weight. In cases where there is a conflict, these weights may be used to resolve conflicts and the rule with a higher weight is evaluated.

Having identified a rule, the rules engine platform may then evaluate the rule (operation 335). Evaluating the identified rule may include examining the asserted fact (e.g., for a sample or logical value) or additional facts. For example, where the fact is asserted that a user is driving, the rules engine platform may evaluate a rule conditioned upon a true value for if the user is driving. Generally, a rule evaluates to true where all the conditions of the rule (e.g., facts) are satisfied. In one embodiment, if a rule evaluates to false, another rule may be identified and evaluated, such as a rule having a lesser salience attribute than the first rule.

In some embodiments, multiple facts are used to evaluate the rule. For example, a rule of the received plurality may indicate that if it is true that the user is sleeping, then audio output is to be disabled. This rule may require two samples for the rules engine platform to make an inference and, therefore, assert a fact that the user is sleeping: (1) time and (2) motion state. Thus, the rules engine platform may assert a fact for a time sample indicating the current time is 2:00 AM and assert another fact indicating the device is not in motion (or assert a single fact that the user is sleeping). The rules engine platform can then evaluate the rule based on the fact that the user is sleeping because it is early in the morning and the device is not in motion.

In one embodiment, the rule may be evaluated by traversing the organizational structure according to the requirements of the rule. For example, a rule may have three requirements: facts A and B must be true and fact C must be false for the rule to evaluate to true. The organizational structure may be traversed by examining fact A and, where A is true, proceeding to fact B and, where B is true, proceeding to fact C. If fact C is then false, the rule evaluates to true. It is possible that the facts A, B, and C come at different rates and at different instances of time. In such cases, the facts may be cached in the repository and re-read when each new fact comes in.

After evaluating one or more rules, the rules engine platform performing the method 300 determines one or more actions using the evaluation (operation 340). In some embodiments, such as where a rule evaluates to true, this action is included in the “then” clause of a conditional statement defining the rule. Alternatively, the determined action may be to do nothing. In relation to FIG. 1, the rules engine 132 may determine the action.

In some embodiments, a plurality of actions may be determined where the rule evaluates to true. A plurality of actions may be determined where the rule's result affects a plurality of modules within the device and/or where the rule's result is to be implemented differently across a plurality of modules. The plurality of actions may be generally broadcast so that each module receives the actions. In other embodiments, a respective action of the plurality is adapted for a specific module or type of module (e.g., messaging application modules or location-based application modules). A respective action may be adapted for a specific module or module type based on, for example, metadata associated with the rule.

In one embodiment, the action is determined in conjunction with metadata associated with the rule, such as an access control list. Therefore, the action can be determined so that the result of the rule does not conflict with permissions that may be configured in the device. Alternatively, the action can be determined so that the result of the rule is reconciled with such permissions. For example, the result of a rule evaluating to true may be to notify the user, but permissions configured in the device have disabled audio notifications; therefore, the action may be determined to graphically notify the user.

It is possible that different modules running on the device may provide different rule sets. In such cases, the rules engine platform may choose to evaluate them separately for privacy reasons and so that the rules of one application does not interfere with the rules of the other application. For example, the rules engine platform 132 may evaluate rules according to an access control policy.

In some embodiments, a determined action updates a fact at the repository (decision block 345). Therefore, the rules engine platform performing the method 300 may assert a fact from the determined action (operation 325). Consequently, one or more additional rules may be identified and evaluated, as described above.

Following the determination of an action, the rules engine platform performing the method 300 sends the determined action (operation 350). Sending the determined action can be facilitated by, for example, an interface (e.g., the rules engine interface 131) of the rules engine platform. According to other embodiments, the determined action can be sent using the operating system or ASIC. In some embodiments, a determined action affects a plurality of modules within a device. Therefore, the rules engine platform may be configured to send the determined action in a plurality of formats to a plurality of modules.

FIG. 3B shows an example of a method 360 performed by a rules engine platform within a portable electronic device according to one embodiment of the invention. The operations of FIG. 3B are illustrative and are not necessarily performed in the order depicted. The method 360 can be performed by the rules engine platform 130 of portable electronic device 100 shown at FIG. 1; for example, the operations of the method 360 can be performed by the rules engine interface 131 and/or the rules engine 132. The rules engine platform executing the method 360 can be communicatively coupled with other components of a device in which it is implemented, such as modules and a processor.

Initially, the rules engine platform receives a plurality of rules which may influence or govern the behavior of one or more modules communicatively coupled with the rules engine platform (operation 365). Rules may be dynamically received at runtime from a module communicatively coupled with the rules engine platform, from a remote source (e.g., the cloud or a URI), or from a local source (e.g., a directory in memory or removable flash memory device); however, rules may also be predefined (e.g., received at compile time of the rules engine platform). The received rules may update an existing rule base stored in a rules repository (e.g., the rules repository 133) or may be received at design time or other compile time of the rules repository. In one embodiment, the plurality of rules may be received in response to a request from the rules engine platform, such as a query.

The rules engine platform may construct an organizational structure in response to the received plurality of rules. The organizational structure may indicate a start state where the rules engine platform is newly initialized. In one embodiment, the organizational structure includes a number of facts that cause a rule to evaluate to true. The facts may initially be asserted to a default, such as null or false. The rules engine platform may also receive a plurality of rules that updates an existing organizational structure. The rules engine platform is then configured to update the existing organizational structure to incorporate the plurality of received rules, for example, by modifying existing requirements, removing obsolete requirements and identifying newly shared requirements.

As appropriate, a fact is asserted in a repository pursuant to one of a received sample and an expected sample, such as a sample received from a module 101-106 (operation 370). In one embodiment, the fact is only asserted where a sample or the absence thereof substantively updates the facts (e.g., changes the truth value of a fact). The fact may be asserted in the repository by being stored in memory, such as RAM, cache memory, a buffer, or a combination of memory locations for instant access as well as future access. The fact may be asserted as a combination of samples or facts (e.g., an inference), which may already be stored in the repository (e.g., a repository 133, 134). In one embodiment, the fact is asserted by updating the organizational structure to reflect the update. Additionally, the fact may be added to persistent storage, such as non-volatile memory.

In some embodiments, a plurality of facts may be asserted pursuant to a received or expected sample—e.g., a received sample or an expected sample may necessitate the contemporaneous update of more than one fact. Particularly, this may be the case for a fact that is asserted from one sample and one or more facts that are asserted from a plurality of samples or facts that includes the one sample.

In accordance with facts in the repository, the rules engine platform performing the method 300 is configured to identify one or more rules (operation 375). As illustrated, the rules engine platform may identify a rule based on the asserted fact (e.g., where the asserted fact is required to satisfy the rule's condition). Alternatively, a rule may be identified where no facts are updated, such as at the initialization of the rules engine platform or where rules are to be identified at a specific time (e.g., according to a clock signal). A rule can be identified and subsequently selected from a rules repository (e.g., rules repository 133). However, the rule may not be immediately evaluated, but may be buffered or cached to expedite evaluation when an additional fact is asserted that causes the rule to evaluate to true.

In some embodiments, a rule is identified in accordance with a conflict resolution agenda, such as a hierarchy of rules or a salience attribute of the rule in relation to other rules. Identifying a rule according to a conflict resolution agenda may reduce occurrences of instances wherein a plurality of rules may be relevant to the facts in the repository but have conflicting results when evaluated to true. Further, a rule may be identified pursuant to a context. Consequently, rules that may be relevant to the facts in the repository but are irrelevant to a context of interest (e.g., the instant context, an anticipated context or a frequent context) may be bypassed in favor of identifying a rule that is relevant to the context of interest.

In certain embodiments, each rule has an associated weight suggesting the importance of the rule. For example, a rule with a higher weight implies that it takes precedence over a rule with a lower weight. In cases where there is a conflict, these weights may be used to resolve conflicts and the rule with a higher weight is evaluated.

Having identified a rule, the rules engine platform may then evaluate the rule (operation 380). Evaluating the identified rule may include examining the asserted fact (e.g., for a sample or logical value) or additional facts. For example, where the fact is asserted that a user is driving, the rules engine platform may evaluate a rule conditioned upon a true value for if the user is driving. Generally, a rule evaluates to true where all the conditions of the rule (e.g., facts) are satisfied. In one embodiment, if a rule evaluates to false, another rule may be identified and evaluated, such as a rule having a lesser salience attribute than the first rule.

In some embodiments, multiple facts are used to evaluate the rule. For example, a rule of the received plurality may indicate that if it is true that the user is sleeping, then audio output is to be disabled. This rule may require two samples for the rules engine platform to make an inference and, therefore, assert a fact that the user is sleeping: (1) time and (2) motion state. Thus, the rules engine platform may assert a fact for a time sample indicating the current time is 2:00 AM and assert another fact indicating the device is not in motion (or assert a single fact that the user is sleeping). The rules engine platform can then evaluate the rule based on the fact that the user is sleeping because it is early in the morning and the device is not in motion.

In one embodiment, the rule may be evaluated by traversing the organizational structure according to the requirements of the rule. For example, a rule may have three requirements: facts A and B must be true and fact C must be false for the rule to evaluate to true. The organizational structure may be traversed by examining fact A and, where A is true, proceeding to fact B and, where B is true, proceeding to fact C. If fact C is then false, the rule evaluates to true. It is possible that the facts A, B, and C come at different rates and at different instances of time. In such cases, the facts may be cached in the repository and re-read when each new fact comes in.

After evaluating one or more rules, the rules engine platform performing the method 360 determines one or more actions from the evaluation (operation 385). In some embodiments, such as where a rule evaluates to true, this action is included in the “then” clause of a conditional statement defining the rule. Alternatively, the determined action may be to do nothing.

In some embodiments, a plurality of actions may be determined where the rule evaluates to true. A plurality of actions may be determined where the rule's result affects a plurality of modules within the device and/or where the rule's result is to be implemented differently across a plurality of modules. The plurality of actions may be generally broadcast so that each module receives the actions. In other embodiments, a respective action of the plurality is adapted for a specific module or type of module (e.g., messaging application modules or location-based application modules). A respective action may be adapted for a specific module or module type based on, for example, metadata associated with the rule.

In one embodiment, the action is determined in conjunction with metadata associated with the rule, such as an access control list. Therefore, the action can be determined so that the result of the rule does not conflict with permissions that may be configured in the device. Alternatively, the action can be determined so that the result of the rule is reconciled with such permissions. For example, the result of a rule evaluating to true may be to notify the user, but permissions configured in the device have disabled audio notifications; therefore, the action may be determined to graphically notify the user.

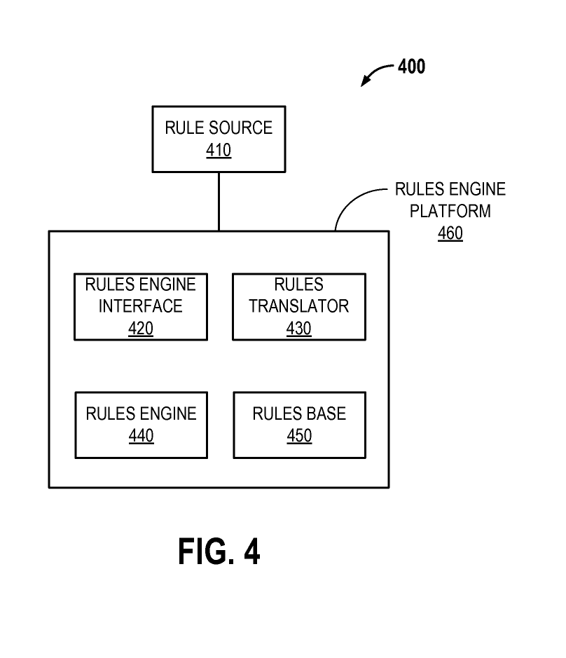

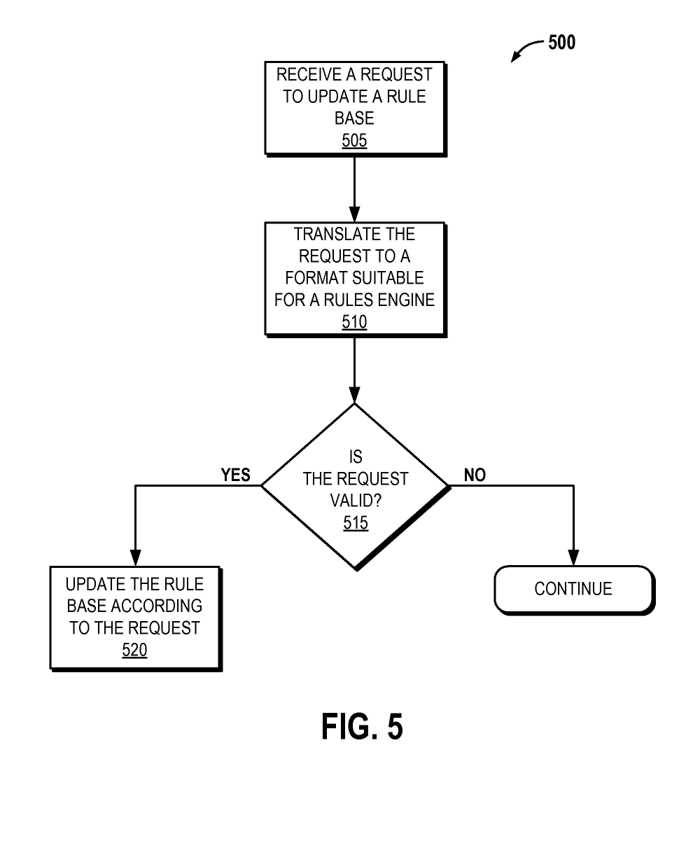

Turning to FIG. 4 and FIG. 5, a system and method for receiving an update to a rule base are shown. Beginning first with the system 400 for adding a new rule, a rules engine platform 460 can be the rules engine platform 130 of FIG. 1. Correspondingly, the rules engine interface 420 can be or can include the rules engine interface 131, the rules engine 440 can be or can include the rules engine 132 and the rule base 450 can be stored in the rules repository 133 of FIG. 1.

A rules translator 430 can be implemented within the rules engine platform 460 and may be integrated with the rules engine interface 420 and/or the rules engine 440. However, the rules translator 430 can also be communicatively coupled to the rules engine interface 420 or the rules engine 440. In some embodiments, the rules translator 430 can be a compiler, interpreter or other similar mechanism for translating a rule update into a format suitable to be interpreted by the rules engine 440.

A rule source 410 is the point of origination for an update to the rule base 450. The rule source 410 can provide rules that are static and precompiled. Alternatively, the rule source 410 can provide dynamic rules that are created in response to user input or are automatically created. The rule source 410 may provide updates for the rule base 450 by adding, updating or deleting rules. Therefore, the rule base 450 can be updated at runtime to support customization and context awareness of a device implementing the rules engine platform 460.

In some embodiments, the rule source 410 can be or can include any of the modules 101-106 of FIG. 1. For example, a user can define a parameter through one of the application modules 105-106 which creates a new rule or modifies an existing rule. In other embodiments, the rule source 410 can introduce precompiled rules. In such embodiments, the rule source 410 can be a file (e.g., a binary file from an SD card), a uniform resource locator (URL) (e.g., binary rules from the URL), or an asset (e.g., an asset loaded from an asset directory). Alternatively, the rule source 410 is included as part of the rules engine platform 460. For example, the rule source 410 may be a “smart” engine such as a context awareness engine or an ambient intelligence engine. A smart engine can provide rules based on a context.

The system 400 of FIG. 4 can implement the method 500 of FIG. 5. Initially, a request is received to update a rule base (operation 505). In an embodiment of FIG. 4, the rule source 410 requests an update to the rule base 450 through the rules engine interface 420. The request to update the rule base may be a new rule, an updated rule, or a request to delete a rule. The request can be dynamically received at runtime, such as when a context is changed or a user interacts with a module.

Thereafter, the request is translated into a format suitable for a rules engine (operation 510). This translation operation can be performed by the rules translator 430 of FIG. 4. The translation operation can be done dynamically at runtime so that rule updates can immediately take effect. In some embodiments, the request requires little or no translation, such as where precompiled rules are received. Alternatively, the request is received as high-level code and compiled to a format that can be interpreted by a rules engine.

In one embodiment, the request is validated before updating the rule base (decision block 515). For example, a request to add a rule may conflict with another rule of a higher priority or require a fact that conflicts with an access control policy. In some embodiments, the request may be to delete a rule that cannot be deleted (e.g., according to an access control policy or metadata associated with the rule).

In another embodiment, the request is validated in response to user input. For example, the requested rule update may result in sending a SPS location to an application module and, therefore, the user may be prompted for input indicating whether the application module may receive the SPS location. If the request is invalid, the request may be ignored. In one embodiment, the source of the request is notified that the request cannot be accepted.

Where the request is valid, a rule base is updated according to the request (operation 520). For example, a new rule may be added or an existing rule may be modified or deleted. In another embodiment, the rule base is updated by updating a hierarchy of rules or one or more salience attributes of rules. For example, rules relevant to one context may be irrelevant to a second context and, therefore, less salient during rule selection/identification. Additionally, an organizational structure may be updated as a consequence of the updated rule base. For example, new requirements for facts may be introduced or the fact base may be updated so that different facts are asserted. In some embodiments, the rule base is updated after the request is processed. The request may be processed by determining its relationship or affect on the rule base. For a request to add a new rule, the new rule may be, for example, assigned to a hierarchy of rules or assigned a salience attribute.

FIG. 6 shows a flow diagram of an example of a method 600 for evaluating a rule according to the transitioning state of a user of a device. Thus, the transitioning state of the user is inferred based on the occurrence or absence of a plurality of samples. The method 600 can be implemented, for example, by the rules engine platform 130 of FIG. 1 and the operations can be performed by the rules engine interface 131 and/or the rules engine 132. In the method 600, the rules engine is subscribed to at least two sampling modules: (1) a motion state module (e.g., an inertial sensor) and a (2) Wi-Fi module. Thus, the motion state module is configured to provide samples for motion state and the Wi-Fi module is configured to provide samples for Wi-Fi (e.g., a Wi-Fi signature and/or Wi-Fi transmission). A respective one of these modules can be or can include a module 101-106 shown in FIG. 1.

To begin, the rules engine platform implementing the method 600 determines whether a sample for a new motion state has been received, such as a sample received from a module 101-106 (decision block 610). In some embodiments, the rules engine platform may examine a fact asserted from a motion state sample (e.g., a repository 133, 134), such as by examining a truth value of the fact. Where a fact indicates that a new motion state sample has been received, the rules engine platform proceeds to another fact examination. At the second examination, the rules engine platform determines whether a sample for motion state has been received within a first time frame, such as the last five seconds (decision block 620). The rules engine platform may examine a fact that is the same as the first fact, such as by examining a timestamp of the fact to determine when the motion state sample was received. However, this fact may be a different fact asserted from a motion state sample.

Where a new motion state has been received within the first time frame, the rules engine platform performing the method 600 determines whether the last Wi-Fi signature has been received within a second time frame, such as the last thirty-three seconds (decision block 630). The rules engine platform may examine a fact related to Wi-Fi signatures (e.g., a fact stored in a repository 133, 134) to determine when the last Wi-Fi signature sample was received. Here, the inference is that if the portable electronic device is moving outside of a last-detected Wi-Fi signature, then the received motion state samples indicate that the device is travelling across a distance and not just undergoing dramatic movement in a confined area. This fact may be asserted from a Wi-Fi signature sample, or may be asserted as the absence of a Wi-Fi signature sample.

Where the last Wi-Fi signature is determined to be at least thirty-three seconds old, the rules engine platform performing the method 600 performs a final evaluation. For the final evaluation, the rules engine platform evaluates the current motion state (decision block 640). The rules engine platform may make this evaluation by examining a fact, which may be the same as the first fact or a different fact. For example, the first fact may be asserted again (i.e., updated) pursuant to a new motion state sample (e.g., a timestamp associated with the fact may be updated) or the first fact may be asserted again to indicate that no new motion state samples have been received. In other embodiments, a motion state sample is cached so that an inference can be made without asserting the motion state sample as a fact.

Where the evaluation of the motion state sample by the rules engine platform indicates the device is not stationary, the rules engine platform makes an inference that the user is transitioning (operation 650). The rules engine platform may assert a fact used to evaluate rules from this inference. For example, for a rule that evaluates to true where the user is transitioning, the rules engine platform can determine an action and/or assert another fact that causes another rule to be evaluated. Additionally, the rules engine platform may iterate through the method 600 again.

Conversely, where any of the preceding evaluations is negative, the rules engine platform implementing the method 600 makes an inference that the user is not transitioning (operation 660). The rules engine platform may assert a fact from this inference, such as by updating a fact for the transition state of a user. The rules engine platform can thereafter determine an action and/or evaluate another rule according to a user that is not transitioning. Additionally, the rules engine platform may iterate through the method 600 again.

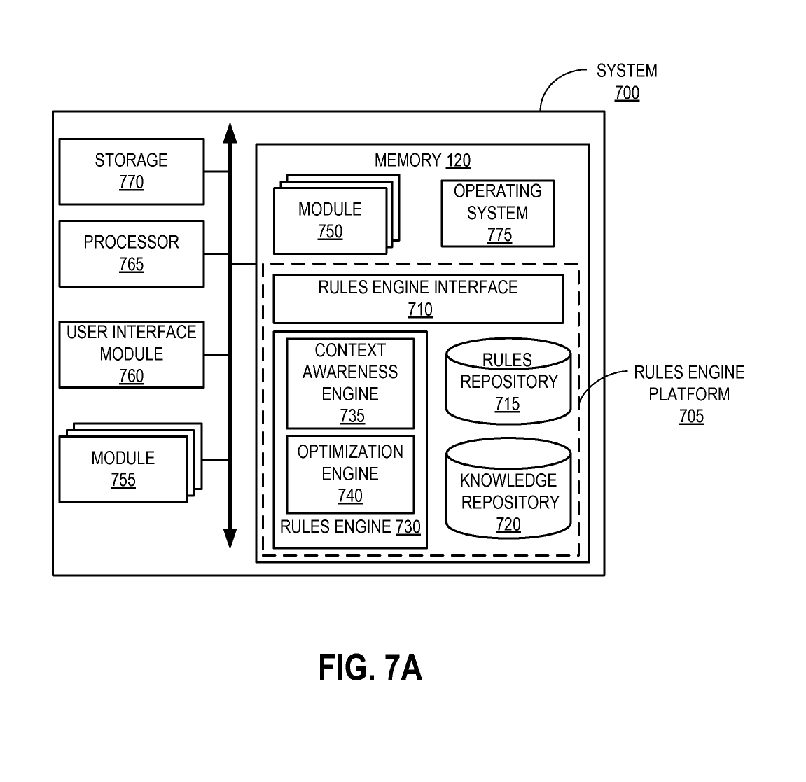

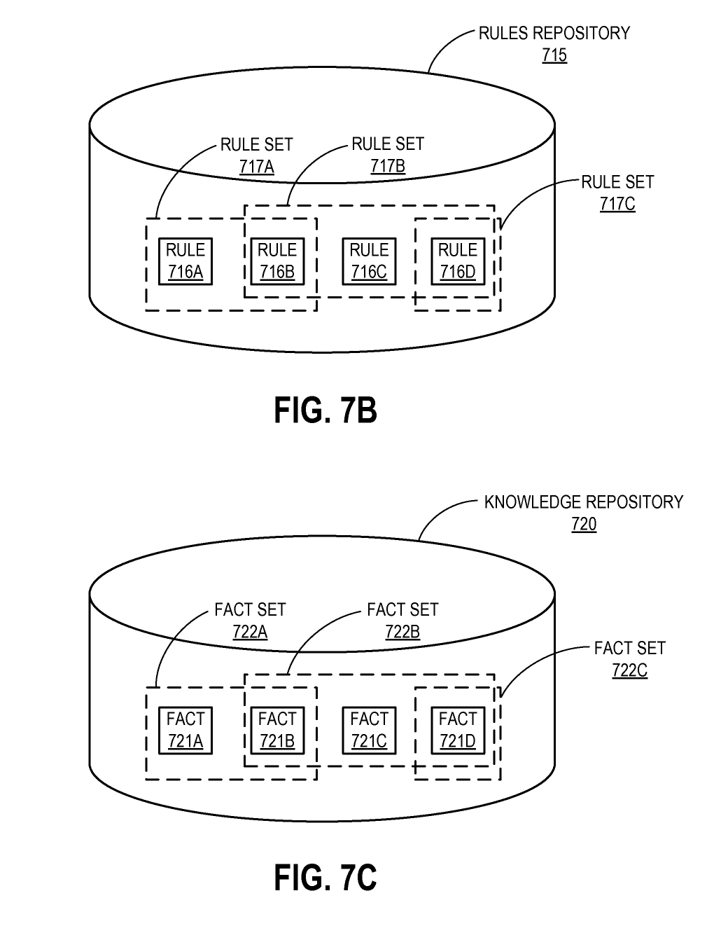

Now with respect to FIG. 7A, a block diagram illustrates an embodiment of a rules engine platform to optimize a system. The system 700 may be implemented in the portable electronic device 100 of FIG. 1. Therefore, the rules engine platform 705 can be or can include the rules engine platform 130, the rules engine interface 710 can be or can include the rules engine interface 131, the rules engine 730 can be or can include the rules engine 132, the rules repository 715 can be or can include the rules repository 133 and the knowledge repository 720 can be or can include the knowledge repository 134. Similarly, modules 750, 755 can be or can include modules 101-106 and can operate as sampling modules and/or reception modules.

In another embodiment, the system 700 can be incorporated into any computing system, such as a personal desktop or laptop computer. Although the system 700 may differ from the portable electronic device 100, modules 750, 755 can be configured to provide data and receive data in an analogous manner as that described with respect to modules 101-106 of FIG. 1. Therefore, modules 750, 755 may be configured to operate as sampling modules and/or reception modules.

The illustrated components of FIG. 7A that are not incorporated in the rules engine platform 705 may be any suitable components for a computing system. In one embodiment, these components are known in the art. For example, the user interface module 760 can allow a user to interact with the system 700, such as a through a graphical user interface (GUI) provided by a module 750, 755 or the operating system 775. To realize this, the system 700 can be communicatively coupled with one or more hardware devices (not shown), such as a display and one or more devices suitable for user input (e.g., a keyboard, a mouse, or touch screen).

In some embodiments, the rules engine 730 includes one or both of a context awareness engine 735 and an optimization engine 740. Both the context awareness engine 735 and the optimization engine 740 may be incorporated within the rules engine 730 or may be separate from and communicatively coupled with the rules engine 730 and/or the rules engine platform 705.

The context awareness engine 735 may be configured to determine a context of the system 700 or a user of the system 700. A context can be, for example, a high-level inference that requires a plurality of samples or is computationally expensive, such as an inference that a user of the system 700 “will be late for a meeting” or “is in a movie.” A context can also be a low-level inference that requires a smaller number of samples or is computationally less expensive, such as the inference that the user is moving. The context awareness engine 735 can derive the context from one or more samples, one or more facts, one or more rules or a combination thereof.

The context awareness engine 735 may subsequently provide the context to the rules engine 730. Thereafter, the rules engine 730 may evaluate or organize rules or facts based on the context. For example, the hierarchy or respective salience attributes of rules may be modified so that rules applicable to the context are given priority. Similarly, facts may be asserted according to the context. In one embodiment, rules and/or facts applicable to the context are loaded (e.g., in a buffer or cache) to optimize rule evaluation. In some embodiments, a context is asserted as a fact in the knowledge repository 720.

In one embodiment, the context awareness engine 735 is configured to derive relationships between facts or contexts. A derived relationship may itself be a context, and therefore may be asserted as a fact. Additionally, a derived relationship may update the rule base. The context awareness engine 735 may derive the relationship between contexts or facts by determining common or recurring patterns between two contexts or facts. For example, the context awareness engine 735 may derive the relationship between a user's home and office from (1) a first context indicating that the user is at home; (2) a next context indicating the user is driving; and (3) a final context indicating that the user is at the office. Thereafter, the context awareness engine 735 can derive a relationship between the home context and office context that indicates the commute time (e.g., the duration of the second context). From the derived relationship, the context awareness engine may provide a rule that “if the user has an office meeting appointment in five minutes and the user is at home, then assert a fact that the user will be late for the appointment.” In another example, the context awareness engine 735 may derive a relationship between (1) a first context indicating that the user is driving; (2) a certain time of day; and a (3) a next context indicating that the user is at home. The context awareness engine 735 may determine that the user commonly transitions from the driving context to the home context at the certain time of day. Accordingly, the context awareness engine 735 can derive a relationship that where the user is driving at that certain time of day, the user is driving home.

In some embodiments, the context awareness engine 735 accesses stored information related to one or more samples in order to derive a context. The information may be stored in, for example, a repository 715-720 or storage 770. In one embodiment, the stored information includes a mapping of a sample to a context. For example, a Wi-Fi signature sample may be mapped to a particular context, such as a context indicating that the user is at work or a context indicating that the user is in a specific room of an office building. A mapping may be received as user input or derived by the context awareness engine 735 from received samples—e.g., where SPS samples indicate the user is quickly transitioning and the context awareness engine 735 frequently receives Bluetooth samples indicating the system 700 is paired with an audio system (not shown), the context awareness engine 735 may derive a mapping from audio system pairing to a context indicating that the user is driving.

The optimization engine 740 is configured to optimize the performance and power consumption of the system 700, such as by reducing the computational load on a processor 765, the access of memory 120 and storage 770 or usage of a power source (not shown). In one embodiment, the optimization engine 740 decomposes the rule structure of a rule to determine the components required for the rule to evaluate to true. From the decomposed rule structure, the optimization engine 740 may compute an optimization scheme to conserve resources, such as an optimization scheme that specifies the rate at which modules 750, 755 are sampled. For example, a rule may evaluate to true for two facts that are asserted from two different samples required from two different sampling modules X and Y. The optimization engine 740 therefore decomposes the rule into a first requirement for an X sample and a second requirement for a Y sample. The first requirement may indicate that for the rule to evaluate to true, an X sample need only be asserted as a fact once every minute. Advantageously, the optimization engine 740 may modify the sampling rate of module X according to an optimization scheme based on the first requirement so that X samples are only received or processed (e.g., used to assert a fact) in one-minute intervals. Correspondingly, the optimization engine 740 may modify the sampling rate of module Y according to the optimization scheme so that Y samples are only received or processed (e.g., used to assert a fact) where an X sample is asserted as a fact within the last minute. Additionally, where an X sample has not been asserted as a fact, the optimization engine 740 may not evaluate the rule because the rule would necessarily evaluate to false.

The rules engine platform 705 can optimize performance of the system 700 by increasing efficiency, increasing speed, decreasing power consumption, decreasing system resource consumption, and other similar attributes that are intended to enhance the performance of the system 700. Therefore, “optimization” does not necessarily mean “the best” or that there is only one resulting effect/possibility of the rules engine platform 705. Thus, the rules engine platform 130 is not required to maximize efficiency or minimize power consumption, but may improve these aspects. For example, the rules engine platform 130 may increase speed while simultaneously increasing power consumption and these increases may be considered optimal in certain embodiments because power consumption may not immediately be a concern in some such embodiments where increased speed is desirable.

In instances wherein the rules repository 715 contains a plurality of rules, each rule of the plurality can be decomposed to its respective component requirements. The optimization engine may thereafter identify the relationships between rules and their respective requirements. Thus, the optimization engine 740 can compute an optimization scheme that reconciles conflicting or shared requirements across the plurality of rules. The implementation of the optimization engine 740 within a rules engine platform 705 may enable the optimization engine 740 to specify how facts satisfy the requirements of a rule, even for rules that contain explicit requirements. For example, three rules A, B and C may each require a fact asserted from samples from a sampling module 750 in order to evaluate to true. Although the requirements for the three rules share a fact, the three rules may differ in the rate at which the fact is required—e.g., rule A requires the fact every second, rule B requires the fact every thirty seconds, and rule C requires the fact every minute. From the three requirements for the fact having disparate rates, the optimization engine 740 can optimize the sampling of the sampling module 750, such as by modifying the sampling rate of the sampling module 750, while still satisfying the requirements of rules A, B and C. In this example, the optimization engine 740 may determine that the optimal sampling rate of the sampling module is fifteen seconds and therefore samples from the sampling module 750 may be received or processed (e.g., used to assert a fact) only in fifteen second intervals.

In some embodiments, the optimization engine 740 can compute one or more optimization parameters for one or both of the modules 750, 755. The optimization engine 740 can compute the optimization scheme with specific optimization parameters for each individual module 750, 755, although one optimization parameter may be applicable to a plurality of modules 750-655. For example, the optimization scheme may include respective optimization parameters that define an optimal rate for samples of a module 750, 755, or the rates at which different types of samples from a module 750, 755 are processed.

The implementation of the optimization scheme may vary according to the embodiment. In some embodiments, the optimization scheme is implemented by the optimization engine 740 as part of the rules engine platform 705. For example, the rules engine interface 710 may ignore samples (e.g., discard samples) received from a module 750, 755 that are unnecessary, such as where the received samples exceed a sampling rate defined by an optimization parameter of the optimization scheme. Similarly, the rules engine 730 may modify its subscription to a module 750, 755 through the rules engine interface 710, such as by reducing the rate at which a module 750, 755 is polled or queried. Further, facts may be asserted at an optimal rate defined by the optimization scheme. As an additional advantage of modifying a subscription to a module 750, 755, the module 750, 755 may deactivate or sleep and only activate or wake when actively queried or polled.

In one embodiment, a respective optimization parameter of the optimization scheme is provided to one or more modules 750, 755 so that a module 750, 755 modifies its sampling rate according to the optimization parameter. In another embodiment, the optimization engine 740 influences the state of a module 750, 755 according to the optimization parameter. Where the optimization scheme indicates that samples from a module 750, 755 are unnecessary, the optimization engine 740 may provide an optimization parameter to the module that includes instructions to deactivate or sleep. Where samples from a module 750, 755 are required according to the optimization scheme, the optimization engine may provide an optimization parameter to the module that includes instructions to activate or awake.

The optimization engine 740 may dynamically update the optimization scheme at runtime in response to changes across the system 700, such as changes to facts, rules, contexts and the like. Dynamic updates to the optimization scheme can be implemented at runtime, such as by modifying an optimization parameter for a module 750, 755. To avoid redundant operations, the optimization engine 740 may only update affected optimization parameters and, therefore, may not compute the entire optimization scheme again.

In one embodiment, the optimization scheme may take into account the relationship between requirements, such as where a decomposed rule structure indicates that a requirement for one module is contingent upon a requirement for a second module. For example, one received sample may trigger the need for a different sample to assert a fact for evaluating a rule. When the first sample is received, the optimization engine 740 dynamically updates one or more optimization parameters for the modules 750, 755 providing the first received sample and the different sample.

In some embodiments, the optimization engine 740 may be adapted to accommodate updates to the rule base stored at the rules repository 715. In response to rules that are added, deleted or modified, the optimization engine 740 may update the optimization scheme as appropriate for the current rules in the rules repository 715, such as by adding, modifying or deleting an optimization parameter for a module 750, 755. For some updates to the rule base, the optimization engine 740 may decompose the rule updates to determine modified requirements. The optimization engine 740 can thereafter use the modified requirements to update the optimization scheme at runtime.

The optimization engine 740 may be also update the optimization scheme in response to a change in facts or contexts, such as a context received from the context awareness engine 735 or a fact asserted from a sample. A change in context or asserted facts may cause different rules to evaluate to true and, as a consequence, affect the requirements of one or more rules. Other rules may be obviated by a change in context or asserted facts and therefore requirements for irrelevant rules may be removed from consideration when the optimization engine 740 updates the optimization scheme.

In one embodiment, the optimization engine 740 computes an optimization scheme based on a conflict resolution agenda, such as a hierarchy or respective salience attributes of rules. The optimization engine 740 may compute the optimization scheme so that the requirements for the rules are weighted according to the agenda. The requirements for rules that are to be selected or identified first may be weighted differently in computing or updating the optimization scheme. For example, an optimization parameter for a module 750, 755 initially may set the rate at which samples from the module 750, 755 are processed by averaging requirements, and thereafter modify the sampling rate where the hierarchy or salience attributes change so that one requirement is given greater weight in updating the optimization parameter.

FIG. 7B and FIG. 7C show the rules repository 715 and the knowledge repository 720, respectively, of FIG. 7A according to one embodiment of the invention. The rule base that is stored in the rules repository 715 may be organized into sets of rules 717A-C. Generally, each set of rules 717A-C is relevant to one or more contexts. For example, when a fact indicates that the user is at home, the rules engine 730 may evaluate a first rule set 717A that applies when the user is at home and/or may ignore a second rule set 717C that applies when the user is at work. Some rule sets 717A-C are relevant to all contexts, such as fundamental rule sets that always are to be evaluated. Furthermore, a context may have a plurality of rule sets 717A-C that are simultaneously relevant. Though not necessary, it is possible that the rules repository 715 has stored therein one or more sets of rules 717A-C that are not relevant to any contexts (these rule sets may be ignored, for example, where the optimization scheme is computed).

The rule base may be regarded as the set of all rules, and each rule set 717A-C may be a subset of the rule base. However, it is contemplated that some rule sets 717A-C may be empty, such as at the initialization of the system 700 or where all of the rules 716A-D have been removed from that set. In some embodiments, sets of rules 717A-C may overlap and, therefore, a rule 716A-D may be a member of more than one rule set 717A-C.

Because a plurality of rules 716A-D and sets 717A-C may be relevant to a single context, the rules 716A-D and sets 717A-C may be organized according to a conflict resolution agenda, such as a hierarchy of rule sets 717A-C. Additionally, the conflict resolution agenda may include respective salience attributes for rules 716A-D. The rules engine 730 may determine the order to evaluate rules based on the conflict resolution agenda. In one embodiment, the salience attribute of a rule 716A-D is subordinate to the hierarchy of rule sets 717A-C. In another embodiment, however, rules 716A-D are prioritized according to their respective salience attributes. Accordingly, where two rules evaluate to true and are conflicting (e.g., result in the determination of irreconcilable actions), the rules engine 730 may determine the appropriate action based on the conflict resolution agenda. In one embodiment, the conflict resolution agenda is dynamically updatable at runtime, such as where the context changes or where the rule base is updated.

Similar to the rule base stored in rules repository 715, the fact base that is stored in the knowledge repository 720 may be organized into sets of facts 722A-C. Generally, each set of facts 722A-C is relevant to one or more rules 716A-D in one or more contexts. For example, when a context indicates that the user is driving, a set of facts 722A-C may be required to evaluate a first rule set 717A that applies when the user is at driving. Likewise, facts 721A-D may be ignored (e.g., not stored or asserted) where they are irrelevant to all evaluable rules for the context. Some fact sets 722A-C are relevant to all contexts, such as fundamental fact sets for rules that are to be evaluated in all instances. Furthermore, a context may have a plurality of fact sets 722A-C that are simultaneously relevant. Though not necessary, it is possible that the knowledge repository 720 has stored therein one or more sets of facts 722A-C that are not relevant to any contexts.

The fact base may be regarded as the set of all rules, and each fact set 722A-C may be a subset of the fact base. However, it is contemplated that some fact sets 722A-C may be empty, such as at the initialization of the system 700. In some embodiments, sets of facts 722A-C may overlap and, therefore, a fact 721A-D may be a member of more than one fact set 722A-C.

In some embodiments, the rules engine 730 identifies one or more relevant rules 716A-D for a context identified by the context awareness engine 735. The rules engine 730 may identify relevant rules 716A-D for a context of interest, such as the instant context or an anticipated or frequent context. In identifying the relevant rules 716A-D, the rules engine 730 can load the relevant rules 716A-D (e.g., into cache or other RAM memory). In one embodiment, the rules engine 730 identifies the relevant rules 716A-D by identifying one or more rule sets 717A-C that are relevant to the context. For example, where the context awareness engine 735 identifies that the user is driving, the rules engine 730 may load a first rule set 717A for fundamental rules that are to be evaluated in all contexts and a second rule set 717C that is relevant to a context in which the user is driving. Consequently, the relevant rules 716A-B, D are loaded for quick evaluation.

Similarly, the rules engine 730 may identify facts 721A-D that are relevant to a context identified by the context awareness engine 735. In one embodiment, however, facts 721A-D are indirectly identified for a context—that is, the rules 716A-D relevant to the context are first identified and the relevant facts 721A-D are identified from the requirements of the relevant rules 716A-D. The rules engine 730 may identify facts 721A-D for a context of interest, such as the instant context or an anticipated or frequent context. In identifying the facts 721A-D, the rules engine 730 can load facts 721A-D (e.g., into cache memory). In one embodiment, the rules engine 730 identifies the facts 721A-D by identifying one or more fact sets 722A-C.

In an illustrative embodiment in which the user is driving, the rules engine 730 may load a first rule set 717A that is relevant to a context in which the user is driving. From the relevant rule set 717A, the rules engine 730 may identify a relevant fact set 722B that is required to evaluate the relevant rules 716A-B for the instant context. Additionally, facts 721A-D may be asserted that are inherent to the context, e.g., a fact may be asserted that the user is transitioning because it is inherent for the context that the user is driving.

To optimize the performance of the system 700, the rules engine 730 may only identify and/or evaluate rules 716A-D that are relevant to a context of interest. Other rules that are irrelevant to one or more contexts of interest may be ignored during identification and evaluation. Similarly, the rules engine 730 may only identify and/or assert facts 721A-D that are relevant to a context of interest. Other facts that are irrelevant to one or more contexts of interest may be ignored, such as by not asserting or otherwise processing those facts. In one embodiment, one or more facts 721A-D that are relevant to a context of interest are updated upon identification. Therefore, the subscription to one or more modules 750, 755 may be updated so that the relevant facts 721A-D are asserted. For example, upon identifying the context that the user is driving, a fact 721A can be asserted to indicate that the user is transitioning.

Rules 716A-D that are irrelevant to a context of interest may be ignored. For example, irrelevant rules 716A-D may be unloaded, such as by removing the irrelevant rules 716A-D from cache memory. Additionally, facts 721A-D that are irrelevant or inaccurate to a context of interested may be ignored (e.g., removed or allowed to expire from cache memory) or reasserted to a default (e.g., a null value). Therefore, resources of the system 700 are not consumed by rules and facts that ultimately will be inconsequential.

In some embodiments, the contextual relevancy of the rules 716A-D and facts 721A-D is complementary to the optimization scheme. Accordingly, the rules engine 730 may identify the sampling requirements for the relevant rules 716A-D and the relevant facts 721A-D and use these sampling requirements to compute or update the optimization scheme, such as by updating a subscription or sampling rate of an optimization parameter. Thus, the rules engine 730 may dynamically update the optimization scheme at runtime in response to different rules 716A-D and/or facts 721A-D that are relevant to a context of interest.

In one embodiment, the rules engine 730 proactively manages samples in response to a context of interest. The rules engine 730 may manage samples by discarding stale or irrelevant samples from storage (e.g., deleting samples from a repository 715, 720 at which the samples are stored). Additionally, the rules engine 730 may modify one or more subscriptions to modules 750, 755 for a context of interest. For example, the rules engine 730 may identify a fact 721A that will be asserted frequently in a context of interest and, therefore, modify a subscription to a module 750 from which the fact 721A is asserted so that the module 750 is more frequently polled for samples.

Additionally, the rules engine 730 may proactively manage samples to provide smart services. The rules engine 730 may interact with the context awareness engine 735 to provide smart services. For example, the context awareness engine 735 can identify that the context indicates that the user is near a person based on, for example, Bluetooth samples or NFC samples. The context awareness engine 735 may subsequently load contact information for the other person, such as a vCard, for the other person so that the user can quickly access the other person's name, profession, employer's name, birthday, and the like.

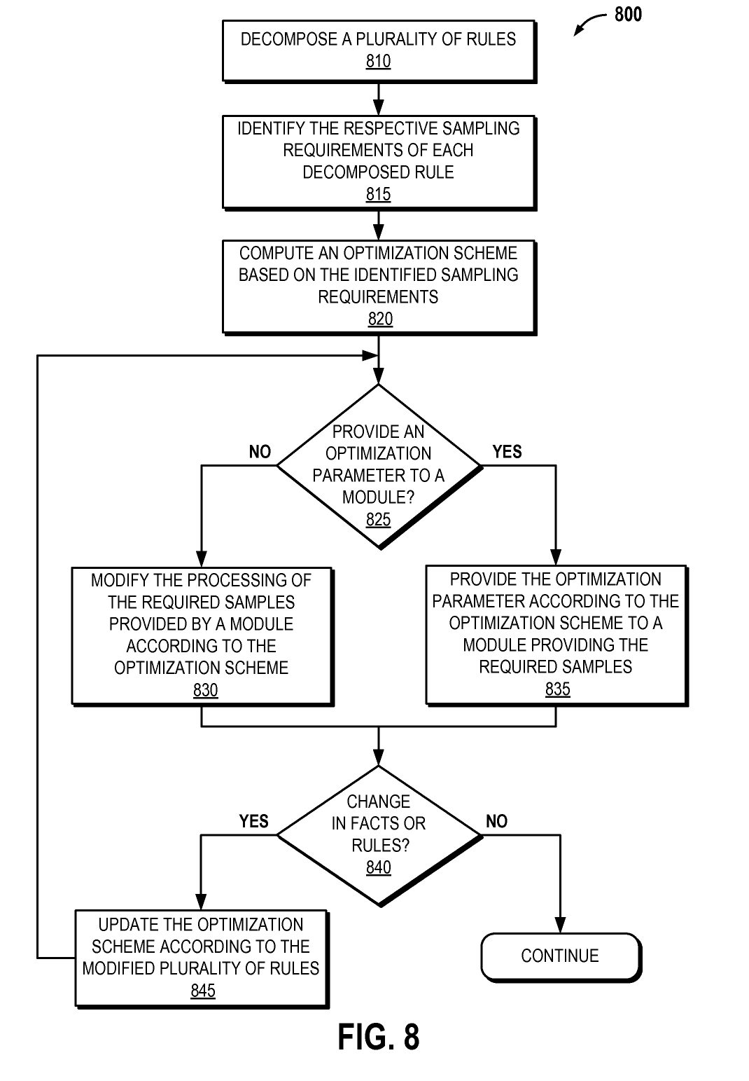

Turning to FIG. 8, a method 800 for optimizing a system implementing a rules engine platform is illustrated according to one embodiment. The operations of FIG. 8 are illustrative and are not necessarily performed in the order depicted. The method 800 can be performed by the rules engine 132 of portable electronic device 100 shown at FIG. 1 or the optimization engine 740 shown at FIG. 7.

To begin, the engine performing the method 800 decomposes a plurality of rules (operation 810). The plurality of rules may be a rule base stored at a repository (e.g., the rules repository 133 or the rules repository 715) that is communicatively coupled with the engine. In some embodiments, the plurality of rules is a subset of a rule base, such as a subset of rules that are relevant to a current context or a subset of a hierarchy of rules. The engine may decompose the plurality of rules to parse out each component of each rule's condition so that a respective rule's components are discretely identifiable. A component can be, for example, a fact, a context, or another rule (e.g., an action from a rule).

Thereafter, the engine identifies one or more respective sampling requirements of each decomposed rule (operation 815). For some rules, identifying the respective sampling requirements may be straightforward, such as where a rule requires a fact that is asserted from a single sample. However, other rules may have more high-level conditional components, such as a context or facts that are inferred from multiple samples or facts. Therefore, the engine can identify the sampling requirements of a rule by determining the constituent sampling requirements of the context or fact. For example, a rule may be conditioned on a fact that the user is “at home,” and the “at home” fact may be asserted either by a Wi-Fi transceiver module connecting to a “home” Wi-Fi network or a SPS module resolving a “home” location. Hence, the engine may identify the requirements as both Wi-Fi transceiver samples and SPS module samples. In some embodiments, the engine interacts with a context awareness engine to identify the sampling requirements. In relation to FIG. 1, a sample may be received or expected from a module 101-106. Similarly, in relation to FIG. 7, a sample may be received from a module 750, 755.

In some embodiments, a rule is dependent upon one or more other rules and thus the rule's sampling requirements are not directly identifiable. The engine may identify the requirements of the rules from which a rule depends to identify the one or more sampling requirements that are fundamental to the dependent rule. For example, a first rule requires a fact that is asserted from second rule, such as a fact asserted from an action determined by the evaluation of the second rule. Therefore, identifying the sampling requirements of the first rule requires identifying the sampling requirements of the second rule. The engine may iterate through a plurality of rules to identify a dependent rule's sampling requirements, such as where the dependent rule includes multiple or nested rule requirements.

Using the identified sampling requirements for each rule of the plurality, the engine computes an optimization scheme to benefit the system in which the engine is implemented (operation 820). In one embodiment, the optimization scheme may include one or more optimization parameters for one or more modules. An optimization parameter may include the rate at which a sampling module provides samples or the rate at which samples are stored or processed (e.g., asserted as facts). This optimization parameter is generally satisfactory for one or more rules requiring such samples while simultaneously minimizing computationally expensive operations or power consumption (e.g., by repeatedly asserting a fact or determining a context).

In one embodiment, the optimization parameter includes instructions for modifying the state of one or more modules. Thus, the optimization scheme may provide an optimization parameter that includes an instruction to a module to deactivate or sleep, such as where samples from the module are unnecessary or where no actions will be provided to the module. Similarly, the optimization scheme may provide an optimization parameter that includes an instruction to a module to activate or awake. Such optimization parameters can be provided to a module for every state change according to the optimization scheme, or may be provided to the module as a policy to which the module adheres (e.g., a schedule of when to wake or sleep).

In some embodiments, the engine performing the method 800 can compute the optimization scheme using one or more algorithms that may be stored in the engine or otherwise accessible thereto, such as in local storage. The algorithm can be adapted to accommodate the relationship between the sampling requirements across multiple rules. For example, two or more rules may require the same fact, though the rates at which the fact is required may vary. A simple optimization scheme may be computed by averaging the rate at which the fact is required, so that the fact is only asserted at the average rate.

An algorithm for computing an optimization scheme may take into account any number of factors. In one embodiment, the relationships between rules are identified and used in the algorithmic computation of the optimization scheme. For example, a first rule that evaluates to true may result in the evaluation of a second rule. If the first rule infrequently evaluates to true, then the requirements of the second rule may be less influential to the optimization scheme (e.g., other requirements may be emphasized over the second rule's requirements). Additionally, rules or sets of rules may be evaluated according to a conflict resolution agenda (e.g., a hierarchy or salience of rules) and the optimization scheme may be computed so that the requirements for the rules are weighted according to the agenda.

In one embodiment, an algorithm for computing the optimization scheme incorporates one or more contexts of interest, such as the instant context, an anticipated context, or a frequent context. Accordingly, rules that are irrelevant to an incorporated context may be excluded from the computation of the optimization scheme. Additionally, a hierarchy of rules may change according to contexts, and therefore rules may be differently weighted for different contexts. In even another embodiment, the optimization scheme updates an agenda for resolving conflicts between rules according to contexts. For example, the hierarchy of rules may be changed according to the context or a different subset of rules may be used to update the optimization scheme.

The optimization scheme may be implemented by providing a relevant optimization parameter to a module (decision block 825). However, in some embodiments it may be undesirable or disadvantageous to implement the optimization scheme at one or more modules (decision block 825). Therefore, the optimization scheme may be implemented at the engine performing the method 800 (e.g., the rules engine 132 or the rules engine 730). In one embodiment, the optimization scheme is distributed across the engine and one or more modules. Consequently, some modules may receive and adhere to optimization parameters while other optimization parameters are implemented at the engine.

Where the optimization scheme is implemented by the engine performing the method 800, the processing of one or more samples may be modified according to the optimization scheme (operation 830). In one embodiment, facts are asserted from samples according to one or more optimization parameters for received samples. Accordingly, some received samples may be ignored (e.g., declined or discarded), such as where the received samples exceed an optimal sampling rate included defined by the optimization parameter.

Alternatively, an optimization parameter of the optimization scheme can be provided to an applicable module that is communicatively coupled with the engine performing the method 800 (operation 835). In response, the module adheres to the provided optimization parameter. For example, a module may modify the rate at which it sends samples to the engine in accordance with the optimization parameter. In one embodiment, the optimization parameter influences the state of the module to which it is provided. For example, the optimization parameter may include an instruction to the module to deactivate or sleep. Similarly, the optimal sampling rate may provide an instruction to the module to activate or awake.

Changes affecting the optimization scheme may occur after the optimization scheme has been computed (decision block 840). A change affecting the optimization scheme can be, for example, changes to contexts, rules, facts, or other similar change. If no changes occur affecting the optimization scheme, the existing optimization scheme may remain as implemented.

Where a change occurs that affects the current optimization scheme, the engine performing the method 800 is configured to update the optimization scheme according to the change (operation 845). The engine may update the optimization scheme at runtime in response to changes and dynamically implement the updated optimization scheme. In updating the optimization scheme, the engine may add, modify or remove one or more optimization parameters according to the change. The modification to one optimization parameter may propagate through the optimization scheme to other optimization parameters. In one embodiment, the optimization scheme may take into account the relationship between sampling requirements, such as where a decomposed rule structure indicates that the one sampling requirement is contingent upon another sampling requirement in order for a fact to be asserted. For example, a sample received from a first module may trigger the need for a sample from a second module in order to assert a fact, while also suspending the need for further samples from the first module.

Similarly, the engine may update the optimization scheme in response to a change in the rules, such as an added, modified or deleted rule. In some embodiments, a new or modified rule is first decomposed so that the sampling requirements of the rule can be identified. Thereafter, any affected optimization parameters can be updated.

The engine may also update the optimization scheme in response to a change in facts or contexts. A change in facts or contexts may cause different rules to evaluate to true and, as a consequence, affect the sampling requirements of one or more rules. Other rules may be obviated by a change in facts or contexts and therefore optimization parameters based on such rules may be updated so that the inapplicable sampling requirements are removed from consideration.

Thereafter, the updated optimization scheme may be implemented according to the embodiment (decision block 825). Thus, the engine may modify the way in which samples are processed (operation 830). Alternatively, the engine or may provide an updated optimization parameter to a module, or instruct the module to cease adhering to an optimization parameter, such as by deleting the optimization parameter (operation 835).

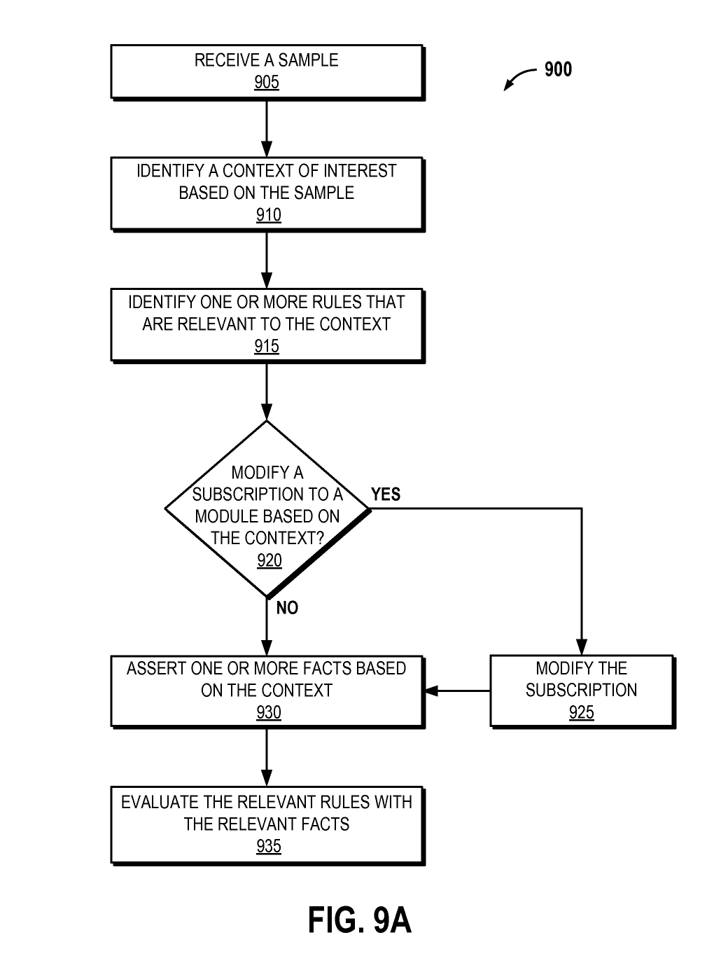

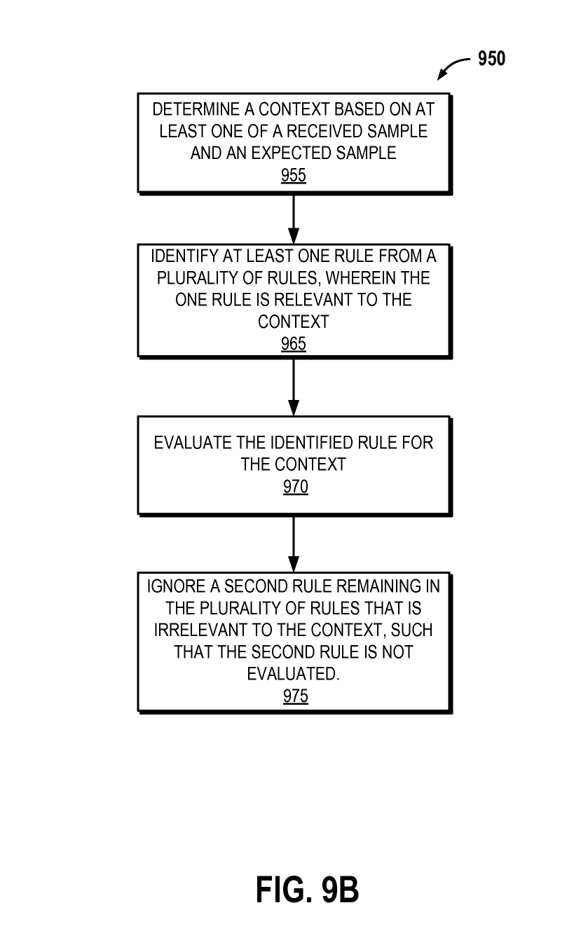

With respect to FIG. 9A, a method 900 for optimizing a system implementing a rules engine platform is illustrated according to one embodiment. The operations of FIG. 9A are illustrative and are not necessarily performed in the order depicted. The method 900 can be performed by the rules engine 132 of portable electronic device 100 shown at FIG. 1. The method 900 may also be performed by the rules engine 730 of FIG. 7, which may be communicatively coupled with the context awareness engine 735.

Initially, a sample is received that is indicative of the circumstance or environment of a user of a system in which the method 900 is performed (operation 905). The sample can be, for example, a calendar event, a motion state, a Wi-Fi signature, or any other type of sample. The sample may be received from a module (e.g., a module 101-106 or a module 750, 755), and may be adapted from its original format (e.g., raw sensor data may be processed). In one embodiment, the sample is asserted as a fact (e.g., into a repository 133, 134 or a repository 715, 720).

From the sample, a context of interest can be identified (operation 910). The context of interest may be the instant context or an anticipated or frequent context. The context can be identified from a plurality of samples in addition to the received samples. However, identifying a context may require the absence of one or more samples.

In one embodiment, a context is identified indirectly from the sample. For example, the context is identified from a fact that is asserted from a sample, or has yet to be asserted from a sample (e.g., the fact is null). Additionally, the context of interest can be identified from a derived relationship between contexts and/or facts, such as where the identification of one context in relation to one fact indicates a second context.

According to one embodiment, applicable information can be identified pursuant to an identified context. The applicable information can be, for example, samples or asserted facts from a knowledge repository pursuant to an identified context (e.g., the knowledge repository 134 or the knowledge repository 720) or can be retrieved from a module (e.g., a module 101-106 or a module 750, 755). For example, when a context is identified indicating that the user has entered a museum, the rules engine platform may be able to determine a room in the museum (e.g., through the context awareness engine 735 or Wi-Fi samples from a module 750, 755) that the user has entered and, responsively, load information about artifacts in that museum room (e.g., the knowledge repository 134 or the knowledge repository 720). In another example, when a context indicates that the user has entered the user's office, the rules engine platform may load information or settings related to the “office” context into a knowledge base (e.g., the knowledge repository 134 or the knowledge repository 720).

By identifying a context of interest, rules that are relevant to the context may be subsequently identified (operation 915). One or more relevant rules may be, for example, rules that are fundamental to the system in which the method 900 is performed. Additional relevant rules may be unique to the identified context or only relevant to certain contexts, such as contexts that share a common fact. Relevant rules may be identified according to a conflict resolution agenda, such as a respective salience attribute associated with each rule. Accordingly, rules that conflict with relevant rules of a higher priority may not be identified.

According to one embodiment, rules within a context can be identified, such as a subset of the set of rules for a specific context. For example, a context may be identified as “work” and the rules engine platform may receive a sample that indicates that the system has entered a geo-fence for the user's office. In response, the rules engine platform can identify a set of rules for the user's office based on the fact that the context indicates that the user is at work and a sample indicates that the user has entered the user's office. Similarly, a context may be that the user is in a family situation (e.g., the user is within a “home” geo-fence or near a plurality of devices that are identified as belonging to members of the user's family) and, consequently, the rules engine platform can identify rules or a set of rules related to a family situation. In one embodiment, the rules for a family situation can be defined as a complement of the rules that are identified for the “work” context. In a third example, a context may indicate that the user is driving and, therefore, only rules related to driving may be identified and loaded by the rules engine platform.

In some embodiments, the relevant rules are not directly identified. Rather, the relevant rules are identified through the selection of one or more rule sets. The rule sets may be associated with one or more contexts so that where a context of interest is identified, the relevant rule sets can be quickly identified. Furthermore, the rule sets may be identified according to a conflict resolution agenda, such as a hierarchy of rule sets that are arranged in order of relevancy to an identified context.

Thereafter, the context, the relevant rules or a combination of the two may be used to determine the relevant facts to be asserted. For some relevant facts to be asserted, one or more subscriptions to one or more modules may need to be modified (decision block 920). In one embodiment, the relevant rules require a modification of one or more subscriptions to one or more modules in order to determine an action, such as where a determined action is to return a sample (decision block 920). Therefore, the engine performing the method 900 may modify the subscription to one or more modules to facilitate the efficient evaluation of the relevant rules (operation 925).

In one embodiment, a subscription to a module is modified pursuant to the actions which may be determined by the evaluation of the relevant rules. The actions that are determined across contexts may vary in conformity with the different relevant rules. Accordingly, samples from one module may be unnecessary for a context of interest. Consequently, the subscription to that module may be modified so that samples from that module are not stored or are stored at a lower rate, such as by reducing the rate a module is polled or reducing the frequency at which samples from a stream are stored. For another module, the converse may be true and, therefore, the subscription to the other module may be modified so that module is more frequently queried or samples are more frequently stored.

In one embodiment, a subscription to a module is modified pursuant to the relevant facts which are to be asserted for the evaluation of the relevant rules. The relevant facts that are asserted across contexts may vary in conformity with the different relevant rules. Accordingly, the subscription to a module may be modified so that one or more relevant facts may be asserted from samples received from that module as required for the relevant rules to be evaluated.

Modifying one or more subscriptions notwithstanding, one or more relevant facts may be asserted based on the context (operation 930). The relevant facts may first be identified before being asserted. The relevant facts may be identified through the selection of one or more fact sets, such as fact sets that are associated with one or more contexts or one or more relevant rules or sets. A relevant fact may be asserted by updating the fact from a sample or the lack thereof, the context of interest, or one more rules. In identifying and/or asserting relevant facts, the relevant facts can be loaded for faster access (e.g., loaded into cache memory).

Not all relevant facts should be asserted based on the context of interest, as some facts will remain valid across one or more contexts. For example, a fact may be asserted for a sample that indicates the user has disabled audible message notifications; this fact may remain valid across contexts that the user is at home, driving to work, and at work.

In one embodiment, facts that are not relevant are asserted to a default, such as null or false, according to a change in context (operation 930). Accordingly, as relevant facts are identified, facts that are not relevant to a context of interest do not consume resources. Alternatively, irrelevant facts are not asserted. For example, the engine may decline to assert facts that are not included in the fact sets that are relevant to the context of interest. Therefore, samples from which such irrelevant facts are asserted may be ignored; although this may also be a consequence of a modification to a subscription.

Subsequently, the identified relevant rules may be evaluated (operation 935). Advantageously, the relevant rules and relevant facts have already been identified, and possibly loaded or cached for fast access. Therefore, the engine may only need to evaluate the identified relevant rules using the relevant facts. Consequently, irrelevant rules and facts may be ignored so that the engine does not consume resources evaluating all rules then determining which action to take based on a context or conflict resolution agenda. In evaluating the relevant rules with the relevant facts, one or more actions may be determined and/or one or more facts may be asserted.

With respect to FIG. 9B, a method 950 for optimizing a system implementing a rules engine platform is illustrated according to one embodiment. The operations of FIG. 9B are illustrative and are not necessarily performed in the order depicted. The method 950 can be performed by the rules engine 132 of portable electronic device 100 shown at FIG. 1. The method 950 may also be performed by the rules engine 730 of FIG. 7, which may be communicatively coupled with the context awareness engine 735.

Initially, a context of interest can be determined based on at least one of a received sample and an expected sample (operation 955). A received sample or an expected sample (e.g., the absence of a sample) can be indicative of the circumstance or environment of a user of a system in which the method 950 is performed. The sample can be, for example, a calendar event, a motion state, a Wi-Fi signature, or any other type of sample. The sample may be received from a module (e.g., a module 101-106 or a module 750, 755), and may be adapted from its original format (e.g., raw sensor data may be processed).

In one embodiment, the sample is asserted as a fact. As appropriate, a fact is asserted in a repository pursuant to one of a received sample and an expected sample, such as a sample received from a module 101-106. In one embodiment, the fact is only asserted where a sample substantively updates the facts (e.g., changes the truth value of a fact). The fact may be asserted in a repository, such as a repository 133, 134 or a repository 715, 720. The fact may be asserted as a combination of samples or facts (e.g., an inference), which may already be stored in the repository. In one embodiment, the fact is asserted by updating the organizational structure to reflect the update. Additionally, the fact may be added to persistent storage, such as non-volatile memory.

In some embodiments, a plurality of facts may be asserted pursuant to a received or expected sample—e.g., a received sample or an expected sample may necessitate the contemporaneous update of more than one fact. Particularly, this may be the case for a fact that is asserted from one sample and one or more facts that are asserted from a plurality of samples or facts that includes the one sample.

The context of interest may be the instant context or an anticipated or frequent context. The context can be identified from a plurality of samples in addition to the received samples. However, identifying a context may require the absence of one or more samples in some embodiments.

In one embodiment, a context is identified indirectly from the sample. For example, the context may be identified from a fact that is asserted from a sample, or has yet to be asserted from a sample (e.g., the fact is null). Additionally, the context of interest can be identified from a derived relationship between contexts and/or facts, such as where the identification of one context in relation to one fact indicates a second context.

By identifying a context of interest, at least one rule can be identified from a plurality of rules, wherein the at least one rule is relevant to the context of interest (operation 965). One or more relevant rules may be, for example, rules that are fundamental to the system in which the method 950 is performed. Additional relevant rules may be unique to the identified context or only relevant to certain contexts, such as contexts that share a common fact. Relevant rules may be identified according to a conflict resolution agenda, such as a respective salience attribute associated with each rule. Accordingly, rules that conflict with relevant rules of a higher priority may not be identified. In some embodiments, a subset of rules that are relevant to the context of interest is identified from the plurality of rules; the at least one rule may be a member of the subset of rules.

Subsequently, the identified relevant rule may be evaluated for the context (operation 970). Advantageously, at least one relevant rule has already been identified, and possibly loaded or cached for fast access. Therefore, the engine may only need to evaluate the identified relevant rule. Consequently, irrelevant rules may be ignored so that the engine does not consume resources evaluating all rules then determining which action to take based on a context or conflict resolution agenda (operation 975). In evaluating the relevant rules, one or more actions may be determined and/or one or more facts may be asserted. In one embodiment, the at least one relevant rule is from the identified subset of rules that are relevant to the context of interest.

The embodiments of a rules engine and/or a rules engine platform as described herein can be used to control, monitor and/or manage all functions of a system, such as a portable electronic device. Such functions can include, but are not limited to, context awareness, module functions (e.g., sensor subsystems or applications), and other system functions (e.g., power management, user input acceptance and processing, etc.). Thus, the rules engine and/or rules engine platform described herein may be used as a controller to determine how and/or when to run sensors, applications, subsystems, and other modules or functions. Likewise, the rules engine and/or rules engine platform described herein may influence calibration, timing, activity state (e.g., on or off) and other related functions of sensors, applications, subsystems, and other modules or functions of a system.

The embodiments described herein may be implemented by a variety of different means that are suitable to provide the described functions. In one embodiment, a computing system, as described herein, includes means for storing a plurality of rules in a rules repository; means for subscribing to a plurality of modules configured to provide a plurality of samples; means for identifying a context of interest based on the subscribing means; means for identifying a first set of rules that are relevant to the context of interest; and means for evaluating at least one rule included in the first set of rules.

Teachings herein may be incorporated into (e.g., implemented within or performed by) an apparatus, such as a computing system, to optimize performance of that apparatus. Embodiments described herein may be amenable to caching and chipset optimization. In some embodiments, this optimization comes at the expense of memory, such as RAM memory, flash memory, ROM memory, EPROM memory, EEPROM memory, registers, or other storage unit suitable for implementation on an apparatus. For example, one or more aspects taught herein may be incorporated into a phone (e.g., a cellular phone), a personal data assistant (PDA), a tablet computer, a mobile computer, a laptop computer, an entertainment device (e.g., a music or video device), a desktop computer, a client computing system, a server computing system or other similar computing system. These systems may have different power and data requirements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, or microcontroller. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, or any other form of storage medium known in the art suitable for a portable electronic device. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, or any other medium that can be used to carry or store desired program code in the form of instructions or data structures and that can be accessed by a computer (e.g., a portable electronic device configured as a computing device). Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory in some embodiments.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method executed by a system associated with a user for adapting a rules engine, comprising:
determining a first context of the system based on at least one of a received sample and an expected sample from a first sampling module;
identifying at least one rule of a first plurality of rules, wherein the identified at least one rule is relevant to the first context;
evaluating the identified relevant rule for the first context; and
ignoring at least one rule remaining in the first plurality of rules that is irrelevant to the first context, such that the at least one rule is not evaluated for the first context.

2. The method of claim 1, wherein identifying the at least one relevant rule comprises:
identifying, from the first plurality of rules, a relevant rule set having a second plurality of rules that are relevant to the first context, including the at least one rule.

3. The method of claim 2, further comprising:
evaluating each rule of the relevant rule set.

4. The method of claim 2, further comprising:
identifying, from the first plurality of rules, a second rule set having a third plurality of rules that are relevant to the first context and are to be evaluated.

5. The method of claim 2, wherein the first context is an office of the user and the relevant rule set is relevant for an office context.

6. The method of claim 1, wherein the first context is one of a location and a geo-fence.

7. The method of claim 6, wherein the first sampling module is one of a cellular module, a Bluetooth module, a Wi-Fi module, a user input module, a near-field communication module, a satellite positioning system module, or an application module stored in memory of the system.

8. The method of claim 1, further comprising:
identifying at least one fact that is relevant to the first context.

9. The method of claim 8, further comprising:
decomposing the relevant rule to identify the at least one fact required by the relevant rule.

10. The method of claim 8, wherein identifying the at least one fact that is relevant to the first context comprises:
identifying a relevant fact set having a plurality of facts that are relevant to the first context, including the at least one fact.

11. The method of claim 8, further comprising:
asserting the at least one fact based on the first context.

12. The method of claim 11, wherein the first context indicates that the user is driving and the at least one fact is asserted to indicate that the user is transitioning based on the first context.

13. The method of claim 8, further comprising:
asserting a second fact that is not relevant to the first context to a default.

14. The method of claim 13, wherein asserting the second fact that is not relevant to the first context comprises:
identifying a second fact set having a plurality of facts that are not relevant to the first context, including the second fact; and
asserting each fact of the plurality of facts in the second fact set to a default.

15. The method of claim 1, further comprising:
determining a sampling requirement for at least one of a second received sample and a second expected sample that is provided by a second sampling module required to satisfy the relevant rule;
computing an optimization scheme based on the sampling requirement of the relevant rule; and
modifying a sampling rate of the second sampling module based on the optimization scheme.

16. The method of claim 15, wherein modifying the sampling rate comprises:
modifying a subscription to the second sampling module.

17. The method of claim 1, further comprising:
determining a plurality of sampling requirements required to satisfy a rule set that is relevant to the first context, wherein the rule set comprises a plurality of rules including the relevant rule;
computing an optimization scheme based on the plurality of sampling requirements of the relevant rule set; and
modifying, based on the optimization scheme, a sampling rate of a second sampling module that is to provide at least one sample for a respective sampling requirement of the plurality of sampling requirements.

18. The method of claim 17, wherein computing the optimization scheme comprises:
evaluating the plurality of sampling requirements;
determining, from the evaluation of the plurality of sampling requirements, that a first sampling requirement of a first rule requires samples from the second sampling module at a first rate and a second sampling requirement of a second rule requires the samples from the second sampling module at a second rate that is different from the first rate; and
computing an optimization parameter that specifies an optimal sampling rate of the second sampling module that is satisfactory for the first rule and the second rule.

19. The method of claim 1, comprising receiving a sample provided by the first sampling module, wherein determining comprises:
identifying a mapping between the sample that is to be provided and a stored context; and
determining that the first context includes the stored context.

20. The method of claim 19, wherein the sample is a Wi-Fi signature and the stored context is a room in a building.

21. The method of claim 1, further comprising:
deriving a relationship between the first context and a second context.

22. The method of claim 21, wherein the first context indicates that the user is at a home and the second context indicates that the user is at an office and the derived relationship includes a travel duration for the user to travel from the home to the office.

23. A computing system, comprising:
a plurality of modules, including at least one sampling module configured to send a sample associated with the sampling module; and
a processor operable to execute a rules engine platform including a rules repository configured to store a plurality of rules; a context awareness engine configured to determine a context of interest of the computing system based on at least one of a received sample and an expected sample from the sampling module; and a rules engine configured to identify, based on the context of interest, a first set of rules included in the plurality of rules that is relevant to the context of interest and evaluate at least one rule of the first set of rules.

24. The computing system of claim 23, wherein the processor is further configured to execute a respective module of the plurality of modules.

25. The computing system of claim 23, wherein the rules engine is further configured to ignore a second set of rules included in the plurality of rules that is not relevant to the context of interest so that no rules included in the second set are evaluated for the context of interest.

26. The computing system of claim 23, wherein the rules engine is further configured to identify a third set of rules included in the plurality of rules that is relevant to the context of interest.

27. The computing system of claim 26, wherein the rules engine is further configured to identify the at least one rule for evaluation according to a conflict resolution agenda where the at least one rule conflicts with a second rule that is included in one of the first and third sets of rules that are relevant to the context of interest.

28. The computing system of claim 23, wherein the context awareness engine is configured to determine the context of interest based on one of reception of at least one sample and absence of the at least one sample.

29. The computing system of claim 23, wherein the context of interest indicates that a user of the computing system is one of in a meeting, in a discussion, on a call, near a geo-fence, near a person, at home, will be late to a meeting, and driving.

30. The computing system of claim 23, wherein the context of interest is one of an instant context, an anticipated context and a frequent context.

31. The computing system of claim 23, wherein the sampling module is one of a cellular module, a Bluetooth module, a Wi-Fi module, a user input module, a near-field communication module, a global positioning system module, or an application module stored in memory of the computing system.

32. The computing system of claim 23, wherein the rules engine is further configured to identify, based on the context of interest, at least one fact that is relevant to the context of interest.

33. The computing system of claim 32, wherein the rules engine is configured to decompose the rules included in the first set of rules that are identified based on the context of interest to identify the at least one fact that is required by the at least one rule of the first set of rules.

34. The computing system of claim 32, wherein the rules engine is further configured to assert the identified fact from one of the context of interest, reception of at least one sample and absence of the at least one sample.

35. The computing system of claim 23, wherein the rules engine is further configured to assert a plurality of facts that are not relevant to the context of interest to one of null and false.

36. The computing system of claim 23, wherein the rules engine is further configured to subscribe to a second sampling module and to modify the subscription to the second sampling module based on the context of interest.

37. The computing system of claim 36, wherein the rules engine is configured to modify the subscription by modifying one of a rate at which the second sampling module is queried, a rate at which the second sampling module is polled and a rate at which a plurality of samples received in a sampling stream from the second sampling module are stored.

38. The computing system of claim 36, wherein the context of interest indicates that a user of the computing system is near a person and further wherein the rules engine platform is configured to modify the subscription to the second sampling module so that a sample including contact information for the person is received.

39. The computing system of claim 23, wherein the rules engine platform further includes an optimization engine that is configured to determine a plurality of sampling requirements required to satisfy rules of the first set that are relevant to the context of interest; to compute an optimization scheme based on the plurality of sampling requirements; and to modify, based on the optimization scheme, a sampling rate of a second sampling module that is configured to provide at least one required sample.

40. The computing system of claim 23, wherein the rules engine is further configured to derive a relationship between the context of interest and a second context.

41. A computing system, comprising:
means for storing a plurality of rules in a rules repository;
means for subscribing to a plurality of modules configured to provide a plurality of samples;
means for identifying a context of interest based on the subscribing means;
means for identifying a first set of rules that are relevant to the context of interest; and
means for evaluating at least one rule included in the first set of rules.

42. A non-transitory computer-readable storage medium having instructions stored therein, which when executed by a computing system, cause the computing system to perform a method, the method comprising:
determining a first context of the computing system based on at least one of a received sample and an expected sample from a first sampling module;
identifying at least one rule of a first plurality of rules, wherein the identified at least one rule is relevant to the first context;
evaluating the identified relevant rule for the first context; and
ignoring at least one rule remaining in the first plurality of rules that is irrelevant to the first context, such that the at least one rule is not evaluated for the first context.
